(19) United States
(12) Patent Application Publication
(10) Pub. No.: US 2026/0332518 A1
(43) Pub. Date: Oct. 22, 2026

(54) IDENTIFYING RADIO FREQUENCY IMPAIRMENTS IN A THIRD GENERATION PARTNERSHIP PROJECT (3GPP) RADIO ACCESS NETWORK

(71) Applicant: Cisco Technology, Inc., San Jose, CA (US)

(72) Inventors: Humberto Jose La Roche, Ocean, NJ (US); Ian McDowell Campbell, Littleton, CO (US); Santhosh Kumar Hosdurg, Dunwoody, GA (US); Muhammad Waris Sagheer, San Ramon, CA (US)

(21) Appl. No.: 19/342,842

(22) Filed: Sep. 29, 2025

Related U.S. Application Data
(60) Provisional application No. 63/789,550, filed on Apr. 16, 2025.

(51) Int. Cl. H04L 45/28; H04L 41/0654

(52) U.S. Cl. CPC H04L 45/28; H04L 41/0654

(57) ABSTRACT

Embodiments herein provide techniques detect/discover and locate RF and/or data plane impairments for one or more service areas of a mobile network. In at least one embodiment, a computer-implemented method can include obtaining, by an analytics function of a mobile network, a flow record for mobile network traffic of a user equipment (UE) that includes a timestamp, five-tuple information, and performance metrics; updating the flow record to include a subscriber identifier, a UE manufacturer a UE model. The method can include identifying an anomaly for the UE based on a comparison between the performance metrics and anomaly criteria; and, upon identifying an anomaly, updating the flow record to include an anomaly flag and a UE location. The method can further include analyzing the flow record to determine whether the anomaly corresponds to an RF impairment of a radio access network (RAN) of the mobile network at the UE location.

### PRIORITY CLAIM

This application claims the benefit of priority under 35 U.S.C. § 119 to U.S. Provisional Application No. 63/789,550, filed Apr. 16, 2025, the entirety of which is incorporated herein by reference.

### TECHNICAL FIELD

The present disclosure relates to wireless networking and communication services.

### BACKGROUND

Networking architectures have grown increasingly complex in communications environments, particularly mobile networking environments. Mobile communication networks have grown substantially as end users become increasingly connected to mobile networks through multiple user devices. As the number of end users continues to increase, management of end user experience becomes more critical.

### BRIEF DESCRIPTION OF THE DRAWINGS

FIG. 1 is an example coverage map illustrating example coverage holes or exclaves that can exist in Third Generation Partnership Project (3GPP) radio frequency (RF) environments.

FIG. 2A is a diagram illustrating a mobile network that may be implemented to facilitate identifying RF impairments in a radio access network (RAN), according to an example embodiment.

FIG. 2B is a diagram depicting an example flow record that can be generated by an Internet Protocol (IP) probe function of the mobile network of FIG. 2A, according to an example embodiment.

FIG. 2C is a diagram illustrating example details for a Network Data and Analytics Function (NWDAF) of the mobile network of FIG. 2A that may facilitate identifying RF impairments in the RAN of the mobile network, according to an example embodiment.

FIG. 2D is a diagram depicting an updated flow record including additional information that can be added to the flow record of FIG. 2A by the NWDAF, according to an example embodiment.

FIG. 3 illustrates example details for a processing pipeline for various operations that may be performed via the mobile network of FIG. 2A to facilitate identifying RF impairments in the RAN of the mobile network, according to various example embodiments.

FIGS. 4A and 4B are a call flow depicting example operations that can be utilized to identify RF impairments utilizing the mobile network of FIG. 2A, according to an example embodiment.

FIG. 5 is a call flow depicting subscribe/notify procedures and operations associated therewith that can be performed based on updates to session management context (SMC) information for a given subscriber/user equipment, according to an example embodiment.

FIG. 6 is a call flow depicting operations for resolving an Internet Protocol (IP) address for a Protocol Data Unit (PDU) session to a session management context (SMC) for a given subscriber/UE to obtain at least a subscriber identifier for the given subscriber, according to an example embodiment.

FIG. 7 is a call flow depicting operations for resolving a subscriber identifier to a UE context (UEC) to obtain at least UE manufacturer and UE model information for a given UE corresponding to a given subscriber identified by the subscriber identifier, according to an example embodiment.

FIG. 8 is a call flow depicting operations for resolving a location for a given UE, according to an example embodiment.

FIG. 9 is a diagram depicting techniques for identifying an RF impairment such as one or more RF coverage holes for a RAN, according to an example embodiment.

FIG. 10 is a diagram depicting techniques for identifying an RF impairment such as one or more RF coverage holes for a RAN based on handover (HO) analysis, according to an example embodiment.

FIG. 11 is a flowchart depicting a method according to an example embodiment.

FIG. 12 is a hardware block diagram of device configured to perform functions associated with operations discussed in connection with embodiments herein.

### DETAILED DESCRIPTION

### Overview

Broadly, embodiments herein provide techniques for operators, including those that may not deploy a radio access network (RAN) (e.g., MVNOs (mobile virtual network operators), managed services providers, connected device platforms, etc.) to discover and locate radio frequency (RF) impairments (broadly, anomalies) that may be present at one or more service areas (locations) of a RAN (e.g., a Third Generation Partnership Project (3GPP) Fifth Generation (5G) RAN, Sixth Generation (6G) RAN, and/or next Generation (nG) RAN) of a mobile network.

Embodiments herein may utilize an Internet Protocol (IP) probe function to obtain one or more flow records for user plane traffic (also referred to herein as traffic flows or packet flows) for a corresponding user equipment (UE). Broadly, a flow record for a given UE can be a timestamped log that can include 5-tuple information (e.g., source Internet Protocol (IP) address, destination (IP) address, source port, destination port, and transport protocol), performance metrics, and/or other data determined and/or inferred from IP probe analysis. In various embodiments, performance metrics included in a UE flow record or records can include, but not be limited to, uplink (UL) and/or downlink (DL) throughput, latency (potentially measured as Round-Trip Time (RTT)), changes in latency, packet loss ratio, etc.

Embodiments herein may facilitate measuring or determining the quality of a mobile network/RAN by combining or enriching data plane per-UE performance data (UE flow records), with subscriber data, such as session management context (SMC) and UE data, such as UE context (UEC), that can be obtained by a network analytics function from one or more sources, such as from one or more elements of a mobile core network (e.g., Fifth Generation (5G) core (5GC)). 3GPP-based call flows and Services Based Architecture (SBA) functions can be used to enrich the flow record with SMC and UEC.

In some instances, a UE flow record can be further enriched with location information for a UE, and, optionally, RF measurement data and/or RF coverage data for a RAN obtained in real-time (RT) or near-RT (‘inline’ or ‘online’, also referred to herein as synchronously), offline/asynchronously (via pre-and/or post-processing), or through a combination of online/offline processing. If a geographic database is known, computational methods such as ray tracing can also be used to create an offline RF coverage map.

An enriched flow record for a UE can be compared against anomaly criteria by the network analytics function in order to determine whether the UE may be experiencing an anomaly. For example, upon determining that one or more performance metrics contained within the UE flow record (e.g., UL/DL throughput, latency, packet loss ratio, variations in throughput, variations in latency etc.) breach or satisfy one or more metrics of the anomaly criteria, the flow record can be flagged to indicate an anomaly for the UE such that further analysis can be performed on the flow record (and potentially multiple flow records of the UE) to determine whether the anomaly corresponds to an RF impairment experienced by the UE (e.g., the UE is experiencing coverage holes) at one or more locations of a RAN of the mobile network or that the anomaly corresponds to a network impairment (e.g., the user plane data for the UE is traversing one or more network elements experiencing congestion, etc.).

In at least one embodiment, the network analytics function that may enrich UE flow records and perform anomaly detection based on the UE flow records and the anomaly criteria can be a 3GPP Network Data Analytics Function (NWDAF). In some instances, the anomaly criteria may be considered Quality of Experience (QoE) criteria indicative of performance metrics that may indicate a poor QoE for a given user/UE, for example, due to increased latency, low throughput, etc.

UE flow records flagged for an anomaly can be stored within NWDAF such that UE flow records can be analyzed in real-time, in near real-time, through pre-processing analysis, and/or post-processing analysis to determine/identify whether an anomaly flagged for a UE flow record (or multiple flow records for a UE or, potentially, for multiple UEs) corresponds to one or more RF impairments at one or more locations and/or data plane impairments that may be present at one or more locations of the mobile network.

In at least one embodiment, a computer-implemented method is provided that may include obtaining, by an analytics function of a mobile network, a flow record for mobile network traffic of a session of a user equipment (UE), wherein the flow record comprises a timestamp, five-tuple information for the mobile network traffic of the session of the UE, and performance metrics for the mobile network traffic of the session of the UE; updating the flow record to include a subscriber identifier associated with the UE; updating the flow record to include a manufacturer of the UE and a model of the UE; identifying an anomaly for the UE based on a comparison between the performance metrics included in the flow record and anomaly criteria; upon identifying the anomaly for the UE: updating the flow record to include an anomaly flag; and updating the flow record with location information for the UE; and analyzing the flow record to determine whether the anomaly corresponds to an RF impairment of a radio access network (RAN) of the mobile network at a location of the UE.

### Example Embodiments

As referred to herein, a user equipment (UE) may be associated with any user, subscriber, employee, client, customer, etc. that seeks communications with a system, such as a mobile network architecture in which the UE may be inclusive of any device that initiates and/or obtains communications involving the system. Thus, a user or subscriber can be characterized as an owner, operator, etc. of a given UE such that information associated with the subscriber (e.g., a subscriber identity, subscriber subscription plan, subscriber policies etc.) and information associated with the UE (e.g., UE model, UE manufacturer, UE capabilities, etc.) can be tied together or otherwise associated with each other for one or more communication sessions involving the UE and the system (e.g., mobile network architecture). As referred to herein, the terms user and UE can be used interchangeably. Further, as referred to herein, the terms mobile network and mobile network architecture can be used interchangeably.

In various embodiments, a UE can include, but not be limited to equipment such as a computer, an electronic device such as an industrial device (e.g., a robot), automation device, enterprise device, appliance, Internet of Things (IoT) device (e.g., sensor, monitor, etc.), a laptop or electronic notebook, a router with at least one wireless wide area (WWA) interface (e.g., cellular radio(s)/interface(s)) and potentially at least one wireless local area (WLA) interface (e.g., Wi-Fi® radio(s)/interface(s), a WWA/WLA (cellular/Wi-Fi®)-enabled telephone/smart phone, tablet, etc., a WWA/WLA (cellular/Wi-Fi®)-enabled vehicle (e.g., car, truck, etc.), and/or any other device, component, element, or object capable of initiating voice, audio, video, media, or data exchanges within a mobile network. Thus, a UE may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies in order to (wirelessly) connect to one or more radio nodes of one or more RANs for one or more sessions with a mobile core network (e.g., a 5GC or the like).

Architectures that facilitate network communications generally rely upon three basic components: a data or user plane, a control plane, and a management plane. Typically, the user plane carries data traffic (e.g., user data traffic, packet flows, or, broadly, flows), while the control plane and the management plane serve the data plane. As referred to herein and in the claims, the term ‘plane’ can refer to a separation of traffic, operations, etc. for a network and/or network element or node. Further, as referred to herein, ‘user plane’ and ‘data plane’ can be used interchangeably to refer to plane through which user data traffic/flows (including a plurality of packets) can are carried.

A timestamped record or log including performance metrics, inferred performance metrics, and/or any other information associated with a user plane packet flow (traffic) of a given UE/UE PDU session within a mobile network can be referred to herein as a flow record.

Radio Frequency (RF) measurements in Third Generation Partnership Project (3GPP) mobile coverage areas typically involve measuring data from UEs. This information can be collected in real time by radio access network (RAN) Operations, Administration, and Maintenance (OAM) systems, by tooling on trace ports, and offline by crowdsourcing techniques such as Minimization of Drive Tests (MDT) or drive tests. However, data from such measurements is typically not useful in situations where a service provider does not own a RAN. Further, even if a service provider does own a RAN, the service provider may wish to correlate RF impairments to actual per-user Quality of Experience (QoE) that may be measured/determined via user plane data.

Embodiments herein provide techniques to facilitate monitoring and analyzing per-user traffic (which can include long-lived traffic) in a mobile network, in real-time (RT) or near real-time (near-RT), and detecting/identifying potential RF anomalies/impairments that may be occurring at one or more locations of the RAN of the mobile network and/or network impairments that may be occurring for one or more data plane elements (e.g., at the user plane function (UPF), at one or more user plane routers/switches for a transport network or the like, etc.) of the mobile network. In at least one embodiment, user traffic can be processed (e.g., in RT, near-RT, pre-processed, and/or post-processed), using statistical analysis and/or, in some instances, artificial intelligence/machine learning (AI/ML), to pinpoint the location(s) (e.g., on a map) of likely RF impairment(s) for one or more RF coverage areas of the mobile network. In some instances, RF impairments can include coverage holes or coverage exclaves that can be detected/identified in accordance with embodiments herein. In some instances, network/data plane impairments can include packet level congestion that can be detected/identified in accordance with embodiments herein.

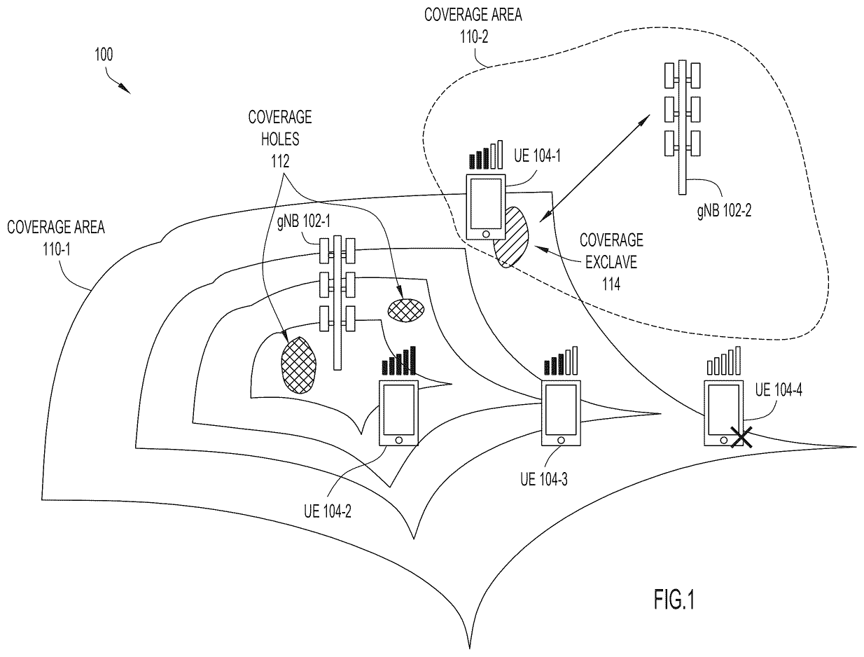

FIG. 1 is an example coverage map 100 illustrating example coverage holes or “exclaves” that can exist in 3GPP mobile network RF environments, for example, for a 3GPP RAN of a mobile network. FIG. 1 includes a number of 3GPP base stations or cell sites, such as a gNodeB (gNB) 102-1 and a gNB 102-2, each of which can provide RF coverage areas, such as an RF coverage area 110-1 provided by gNB 102-1 and an RF coverage area 110-2 provided by gNB 102-2. Broadly, coverages areas 110-1 and 110-2 can be considered to facilitate the RAN of a given mobile network. A number of UEs are also shown in FIG. 1, including a UE 104-1, a UE 104-2, a UE 104-3, and a UE 104-4.

RF coverage areas resist complex characterization. A perfect hexagon tiling of RF coverage areas never exists in practice and further, RF coverage is never homogenous as it varies within the coverage area. There can be “holes” or regions in which UEs may have “no bars” (no RF coverage) within the coverage area that is (supposed to be) covered by a given gNB. For example, coverage holes 112 as shown in FIG. 1 may exist for an RF coverage area 110-1 that is provided by gNB 102-1.

RF “exclaves” may also exist in a RAN and can be characterized as an area within the coverage area of a first gNB where service is also supported by another gNB. For example, a coverage exclave 114 in shown in FIG. 1 that represents a location within the coverage area 110-1 provided by gNB 102-1 that is also covered by the coverage area 110-2 of gNB 102-2 such that UE 104-1 can be served by gNB 102-2 instead of gNB 102-1, potentially, because the signal strength between gNB 102-2 and UE 104-1 is greater than the signal strength between UE 104-1 and gNB 102-1.

Further, there may be areas within a RAN where no RF coverage exists or where RF coverage has an insufficient signal strength to support UE communications. For example, as shown in FIG. 1, UE 104-4 may have no service (no bars) within the coverage area 110-1 due to an insufficient signal strength with gNB 102-1.

Thus, an RF coverage area identified by cell ID (identifier/identity of the gNB providing the RF coverage area) alone is simply not enough of a characterization regarding the location of a UE within a RAN—the coverage area and cell ID associated therewith can cover a large area that could include coverage holes, exclaves, or poor signal strength—for UE location represented a cell ID alone to be useful. Rather, precise positioning/location of a given UE and correlation with subscriber parameters and UE parameters for the subscriber/UE (e.g., UE location, subscriber identity, cell ID, UE manufacturer/mobile information, etc.) would be more useful for determining potential RF impairments at specific locations of a RAN.

Embodiments herein provide techniques for operators, including those that may not deploy a RAN (e.g., MVNOs, managed services providers, connected device platforms, etc.) to discover and locate RF impairments in one or more service areas (locations) of a RAN of a mobile network. The techniques can also be used to identify user plane or network impairments of the mobile network.

3GPP call flows and functions, as discussed in further detail herein, can be used to enrich flow records containing performance metrics and other information regarding PDU session traffic of UEs through use of IP probe functionality and interactions with mobile network elements. The flow records can be fed to and stored by an NWDAF (e.g., 3GPP data lake) for RT processing, near-RT processing, pre-processing, and/or post-processing analysis to determine whether one or more RF impairments may exist at one or more locations of the RAN of the mobile network or whether network impairments may exist within user plane network elements of the mobile network. Thus, techniques provided herein may use IP probe functionality to collect user plane data (one or more flow records) and correlate impairments that may be present in the user plane data to the presence of RF impairments that may exist in the RAN of the mobile network or to network impairments that may exist within the user plane of the mobile network itself.

Through techniques provided herein, subscriber context, such as session management context (SMC) including at least a subscriber identity and UE context (UEC) including at least UE manufacturer and UE model information can be obtained via 3GPP call flows derived from knowledge of the IP address of a Protocol Data Unit (PDU) session of a given UE, which may represent an IP address of the UE for the PDU session. The enrichment of UE flow records with SMC information and UEC information may be considered an integral aspect of embodiments herein.

By relying on user plane procedures/techniques provided herein, embodiments of the present disclosure can be expanded to support RAN-less operators. A primary value of the tooling or techniques provided herein is that the techniques leverage measurements of IP networking performance, advances in UE positioning, and optionally, data obtained through RF coverage measurements and/or RF maps in order to provide a holistic view of per-subscriber/UE Quality of Experience (QoE). The techniques can be used for both 5G-based Fixed Wireless Access (FWA) and mobile services in accordance with embodiments herein. Thus, the conception and design of the techniques disclosed herein are unique.

Per-subscriber QoE can be a function of several factors or performance metrics associated with subscriber traffic, which can be determined using passive methods. Examples of per-subscriber QoE may include, but not be limited to, UL/DL throughputs, latency as measured by RTT in transport protocols, jitter, packet loss ratios, variations in throughput, variations in latency, and/or variations of any other performance metrics. In some cases, it is possible to infer packet loss ratio (for example, in protocols such as Transmission Control Protocol (TCP) that expose sequence numbers carried in packets containing an ACK). In other cases, such as QUIC (Quick User Datagram Protocol (UDP) Internet Connections (QUIC)), packet sequence numbers are shrouded by encryption. In this case other techniques such as “spin bits” defined in the QUIC specification can be used to measure packet loss ratio (PLR) passively.

In accordance with embodiments herein, a flow record for a UE (a flow record of traffic for a PDU session of the UE) can be compared against anomaly criteria in order to determine whether the UE may be experiencing an anomaly within a mobile network. For example, upon determining that one or more performance metrics contained within the UE flow record (e.g., UL/DL throughput, latency/RTT, packet loss ratio, etc.) breach or satisfy various anomaly criteria, the flow record can be flagged to indicate an anomaly for the UE. Further analysis can be performed on the flow record and/or multiple flow records of the UE (and/or of multiple UEs) to determine whether the anomaly corresponds to an RF impairment experienced by the UE (e.g., the UE is in a coverage hole) or a network impairment (e.g., traffic for the UE PDU session is traversing one or more user plane network elements that are experiencing congestion).

Processing to determine anomalies and RF/network impairments, such as real-time (RT) processing, near-RT processing, pre-processing, and/or post-processing of flow records via a 5G standard “data lake” can be performed by a 5GC network analytics function, such as a Network Data Analytics Function (NWDAF), which can deliver inferred RF-level information/analysis and/or user plane-level network information/analysis. In at least one embodiment, analysis/information provided by the NWDAF can be overlayed on an RF coverage map for one or more radio bands of interest of a network operator and a specific UE that may be experiencing a potential RF impairment at a location of a RAN in which the RF coverage map and/or data/analytics associated with the potential impairment can be displayed via Graphical User Interface (GUI), referred to herein as a ‘dashboard’.

Embodiments herein can be applied across a variety of use cases. For instance, in some embodiments, platforms may be enhanced to support positioning beyond a cell ID, such as a New Radio (NR) Cell Global Identity (NCGI) (for 5G) or an ECGI (Evolved UMTS (Universal Mobile Telecommunications System) Terrestrial Radio Access (E-UTRA) Cell Global Identity) (for 4G/LTE), which, as noted above, can be insufficient in some scenarios for identifying coverage holes and other problematic handovers in a RAN. In at least one embodiment, location or positioning information can be delivered by a 3GPP Location Services (LCS) architecture, for example, to further enrich a UE flow record with precise location information for one or more UEs.

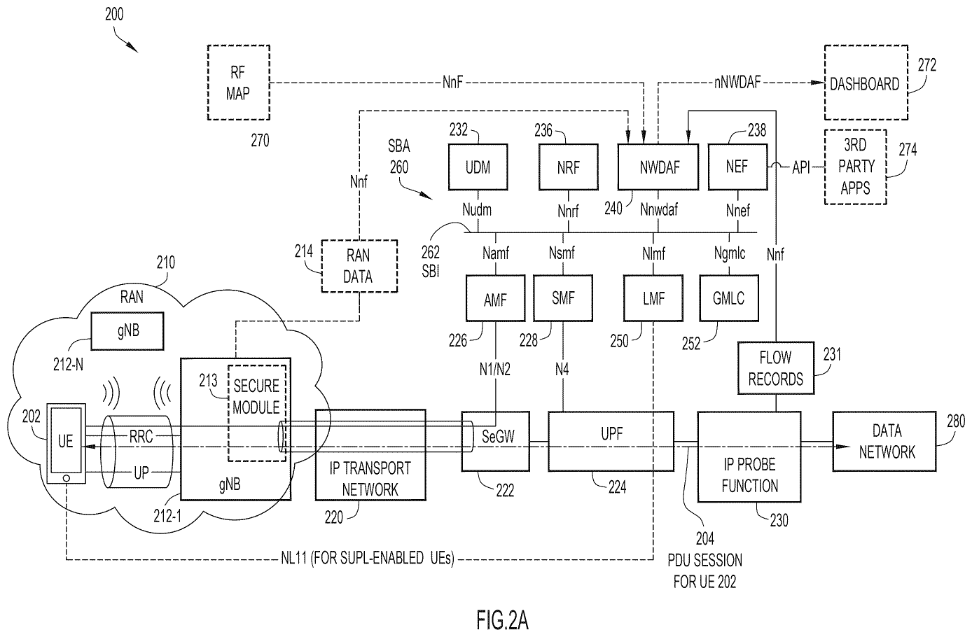

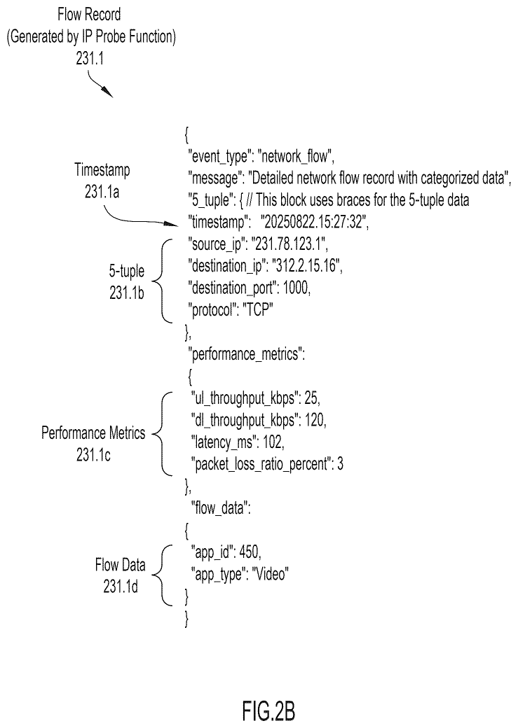

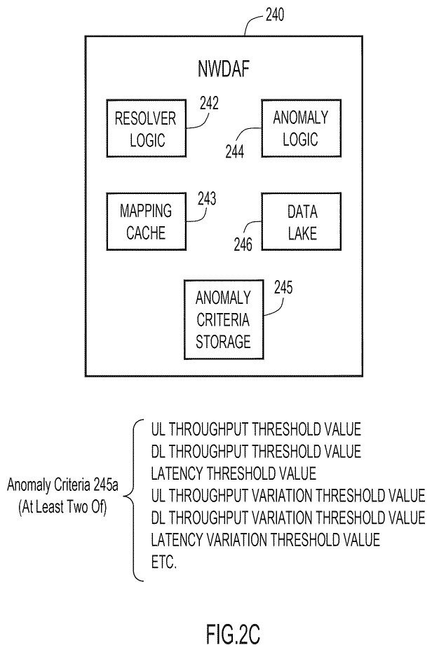

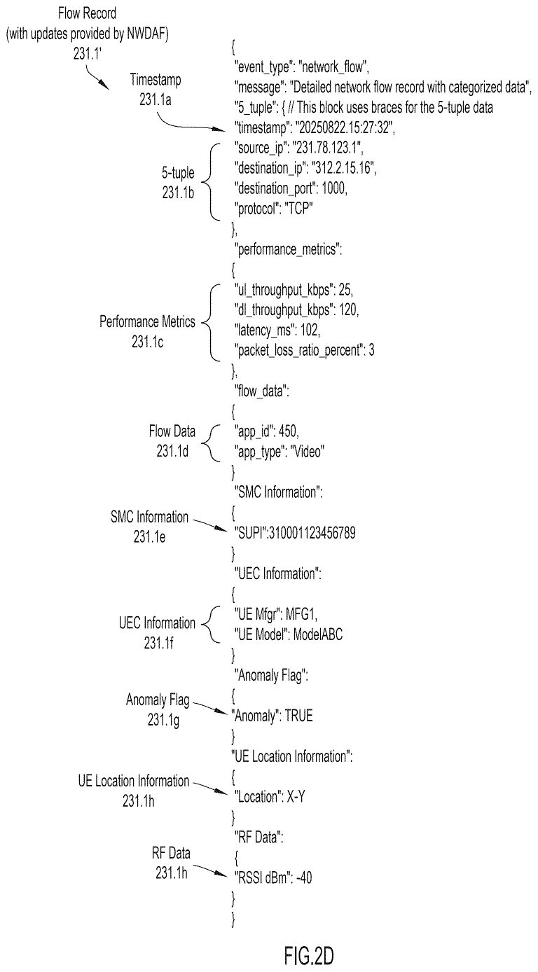

Referring to FIG. 2A, FIG. 2A is a diagram illustrating a mobile network architecture, referred to herein as a mobile network 200, that may be implemented to facilitate identifying RF impairments that may be present in a RAN 210 of the mobile network 200, according to an example embodiment. FIG. 2B is a diagram depicting an example flow record that can be generated by an IP probe function of the mobile network 200 of FIG. 2A, according to an example embodiment. FIG. 2C is a diagram illustrating example details for a Network Data and Analytics Function (NWDAF) of the mobile network 200 of FIG. 2A that may facilitate identifying RF impairments in the RAN 210 of the mobile network 200, according to an example embodiment. FIG. 2D is a diagram depicting additional information that can be added to the flow record of FIG. 2A by the NWDAF, according to various example embodiments.

The mobile network 200 may include RAN 210, an IP transport network 220, a security gateway (SeGW) 222, a user plane function (UPF) 224, an IP probe function 230, a Services Based Architecture (SBA) 260, and a data network 280.

The RAN 210 may include a number of radio nodes or gNBs, such as a gNB 212-1 through a gNB 212-N. Although not shown in FIG. 2A, it is to be understood that the gNBs 212-1-212-N can provide RF coverages areas that can enable one or more UEs to wirelessly connect to one or more of the gNBs 212-1-212-N to exchange communications with the data network 280 via one or more elements of the mobile network 200. For example, a UE 202 is shown in FIG. 2A, which can establish a wireless connection with gNB 212-1. In at least one embodiment (e.g., if mobile network 200 is deployed in Europe), ach gNB 212-1-212-N can include a secure module, such as a secure module 213 as shown for gNB 212-1 that can enable secure communications (e.g., encrypted or protected communications) between the gNB 212-1 and one or more elements of the mobile network 200 via SeGW 222. In at least on embodiment (e.g., if mobile network 200 is deployed in North America), gNBs 212-1-212-N may not include a secure module but gNBs 212-1-212-N can still provide communications with one or more elements of mobile network 200, potentially without encrypted or protected communications. A gNB can also be referred to herein as a ‘cell’ or ‘cell site’. It is to be understood that any number of UEs can be present within mobile network 200.

The SBA 260 may provide a modular framework from which common applications can be deployed using components of varying sources and suppliers. The SBA 260 of the mobile network 200 may be configured such that control plane and/or other functionality and/or common data repositories can be provided by way of a set of interconnected network functions (NFs), each with authorization to access each other's services via a Service-Based Interface (SBI) 262 (sometimes referred to as an SBI message bus) that can provide various interfaces or reference points that define the communications and/or protocols between each of the entities.

For the SBA 260, each of the NFs can assume the role of a service consumer or a service producer, and the NFs may be self-contained, independent, and reusable. In at least one embodiment, the SBA 260 may include an Access and Mobility Management Function (AMF) 226, a Session Management Function (SMF) 228, a Unified Data Management (UDM) function (referred to herein as UDM 232, which can interface with a Unified Data Repository (UDR), not shown in FIG. 2A), a Network Repository Function (NRF) 236, a Network Exposure Function (NEF) 238, a Network Data and Analytics Function (NWDAF) 240, a Location Management Function (LMF) 250, and a Gateway Mobile Location Center (GMLC) 252.

In at least one embodiment, the SBI 262 may employ a Representational State Transfer (REST) interface (e.g., using Hypertext Transfer Protocol “HTTP” 2.0) may include an Namf interface/reference point for AMF 226, an Nsmf interface/reference point for SMF 228, an Nudm interface/reference point for UDM 232, an Nnrf interface/reference point for NRF 236, an Nnef interface/reference point for NEF 238, and an Nnwdaf interface/reference point for NWDAF 240. Although not shown in FIG. 2A, the SBI 262 may include an Nnf interface/reference point to enable any other NFs to exchange communications/data via SBI 262. A plurality of interfaces and/or reference points N1/2, N4, and N11 are also shown in FIG. 2A, which may define the communications and/or protocols between each of the entities, as described in the relevant (evolving) standards documents.

Regarding the NWDAF 240, the NWDAF 240 can expose analytics/analysis performed by the NWDAF 240 via the Nnwdaf to any other NF. In at least one embodiment, NWDAF can expose analytics/analysis to a dashboard 272, which may be representative of any GUI through which the analytics/analysis performed by the NWDAF 240 can be visualized/viewed, interacted with, and/or the like via one or more computing/display devices. For example, one or more locations of RAN 210 can be displayed via the dashboard 272 for various RF impairments that may be determined by the NWDAF 240, along with various analytics/information (e.g., signal strength at/near area(s) of suspected coverage holes or exclaves, number of dropped calls at/near such area(s), average throughput (potentially for different applications) at/near such areas, etc.).

Further, the NWDAF 240 can consume or ingest data, analytics, etc. that may be offered by other NFs via one or more Nnf interfaces, as discussed in further detail herein (e.g., flow records 231 generated by IP probe function 230, an RF coverage map 270 for RAN 210, and/or RAN data 214 that may be generated by the RAN 210/gNBs 212-1-212-N).

As also shown in FIG. 2A, NEF 238 may facilitate one or more Application Programming Interfaces (APIs) that can enable one or more third (3^{rd}) party applications (apps), shown in FIG. 2A as 3^{rd} party apps 274, to provide and/or receive data, analytics, etc.

The elements of FIG. 2A can interface in any manner in order to facilitate operations as discussed for embodiments herein. Regarding the user plane and control plane portions of mobile network 200, the user plane for a PDU Session generally extends from UE 202 (shown in FIG. 2A as ‘UP’) for a wireless connection between the UE 202 and a gNB, such as gNB 212-1, through the gNB 212-1, the SeGW 222, the UPF 224, and the IP probe function 230 to data network 280 such that data plane traffic (UL/DL traffic) can be exchange between the UE and the data network 280 for one or more Protocol Data Unit (PDU) sessions that may be established for the UE 202 via the mobile network 200. Control plane signaling between the UE 202 and the gNB 212-1 can be facilitated via Radio Resource Control (RRC) signaling, as illustrated in FIG. 2A. Certain control plane signaling between the UE 202, the gNB 212-1, and the AMF 226 can also be exchanged/facilitated via the N1 and N2 interfaces, as shown in FIG. 2A. Various control plane signaling between SMF 228 and UPF 224 can also be exchanged via the N4 interface. In some embodiments, if UE 202 is implemented as a Secure User Plane Location (SUPL)-enabled device, control plane signaling between the UE 202 and the LMF 250 can be exchanged via the N11 interface (e.g., for determining UE 202 location). Generally, elements of the SBA 260 can be considered control plane elements of the mobile network 200.

Although only one UE is shown in FIG. 2A, it is to be understood that many UEs may be present in mobile network 200. Generally, mobile core network functions (e.g., UPFs, SMFs, AMFs, etc.) serve multiple UE PDU sessions. Further, in some instances, multiple UPFs can serve a single UE. A classic example for multiple UPFs serving a single UE is voice versus data communications. For instance, one UPF can be dedicated to handling voice communications (e.g., voice calls) and another UPF can be dedicated to handling data communication (e.g., accessing internet webpages, gaming, etc.), such as a UPF dedicated to an enterprise address plan. In this case, filter rules on a given UE direct the user plane packets to the respective UPFs for voice communications versus data communications, based on destination IP address, for example.

Consider various functions, features, operations, etc. that may be provided by various elements of mobile network 200 in accordance with embodiments herein.

IP Probe Function 230: The IP probe function 230 can be used to passively inspect traffic (e.g., packet flows) in both UL (uplink) and DL (downlink) directions (e.g., DL traffic corresponding to traffic being sent to a given UE and UL traffic corresponding to traffic being received from a given UE) in order to generate and/or infer various performance metrics for the traffic and generate flow records for the traffic (e.g., flow records 231 as shown in FIG. 2A). In some instances, the IP probe function 230 can be characterized as a data collector. In some embodiments, the IP probe function 230 can intercept traffic as an in-line function in the data path (user plane) of UE traffic. In some embodiments, the IP probe function 230 can operate using a mirrored copy of UE traffic. Combinations of in-line and mirrored UE traffic can be utilized for determining different performance metrics in some instances (e.g., portions of mirrored traffic can be cached to determine variations in latency, throughput, etc.).

Although shown in FIG. 2A as being deployed between the UPF 224 and the data network 280, the IP probe function 230 can be deployed at any location along the user plane of mobile network 200. In at least one embodiment, the IP probe function 230 can be deployed between the UPF 224 and the SeGW 222. In at least one embodiment, the IP probe function 230 can be embedded within the UPF 224.

It is also possible in some embodiments to deploy the IP probe function 230 at a cell site (for example, embedded in the cell-site router) in which case GTP-u (user plane General Packet Radio Service (GPRS) Tunneling Protocol (GTP)) visibility and unencrypted backhaul may be utilized by the IP probe function 230 to inspect traffic. An IP probe function deployed at a cell site may be smaller or consume less resources (e.g., compute resources) than an IP probe function deployed outside a cell site. For example, a centralized collector, such as the implementation of IP probe function 230 shown in FIG. 2A, may handle the traffic for multiple cell-sites (even an entire network) whereas a cell-site collector may only handle traffic for one cell-site and, thus, can be smaller/consume less resources. For embodiments in which an IP probe function is implemented in a cell-site, a SeGW is not deployed because the IP probe function would only see encrypted traffic.

During operation, the IP probe function 230 can inspect traffic and generate performance data/metrics for traffic of a PDU session of UE 202 (and any other PDU sessions of other UEs that may be present in mobile network 200) to generate a timestamped flow record for the UE traffic. A PDU session 204 is generally illustrated in FIG. 2A as a dashed line extending between UE 202 and data network 280. In one example, the PDU session 204 can be established via the mobile network 200 to facilitate communications/exchanges between UE 202 and an application/ application server deployed in the data network 280 (e.g., the public internet).

The flow records generated for the UE 202 PDU session 204 can be tagged with five-tuple information (e.g., source IP address, destination IP address, source port, destination port, and transport protocol), and potentially other information/metrics that can be inferred about the traffic for the PDU session 204 (e.g., application level protocol). The source IP address of the five-tuple (5-tuple) is the IP address of the PDU session 204 or, stated differently, is the IP address assigned to the UE 202 for the PDU session 204.

The five-tuple (5-tuple) information, performance metrics (potentially including inferred data/metrics) can be included in one or more flow records that can be generated by the IP probe function 230 for the UE traffic. The IP probe function 230 can generate a timestamp that is included in each flow record generated by the IP probe function 230 that indicates the time of creation of each flow record.

In various embodiments, performance metrics/inferred performance metrics for UE traffic can include, but not be limited to, UL and/or DL throughput, latency (measured as RTT in transport protocols such as QUIC and TCP), variations in latency (jitter), variations in UL and/or DL throughput, packet loss ratio, and/or the like. In at least one embodiment, the IP probe function 230 may also collect an application (app) type, an application identifier (ID), and/or any other application information that can be obtained for an application via traffic of a PDU session in which such application information can be included in a flow record for the UE. In at least one embodiment, the IP probe function 230 can also flag long-lived flows, sometimes referred to as “elephant” flows, such as video streaming flows or the like.

In at least one embodiment, the IP probe function 230 can utilize Fluentd or any other collector protocol to log data/generate performance metrics, including a timestamp indicating the time of creation of a flow record, which can be sent to and held in the NWDAF 240, as discussed in further detail herein.

Referring briefly to FIG. 2B, FIG. 2B is a diagram depicting an example flow record 231.1 that can be generated by the IP probe function 230 of the mobile network of FIG. 2A for a PDU session of UE 202, according to an example embodiment. In at least one embodiment, flow record 231.1 can be provided using a JavaScript Object Notation (JSON) encoding format, as shown in FIG. 2A. However, other possible flow record encoding formats can be used including, but not be limited to, Extensible Markup Language (XML), key-value pairs, Concise Binary Object Representation (CBOR), Protobuf, and/or any other structured data encoding formats. As a shown in FIG. 2B, the flow record 231.1 generated by the IP probe function 230 can include a timestamp 231.1a (e.g., Aug. 22, 2025, 15:27:32). The flow record 231.1 generated by the IP probe function 230 can also include source/destination information for the UE 202 PDU session 204, such as a 5-tuple 231.1b (e.g., source IP address (UE 202 IP address)=231.78.123.1, source port number=12, destination IP address (e.g., for an application/application server with which UE 202 is exchanging communications via the PDU session 204)=312:2:15:16, destination port number=1000, protocol=TCP (Transmission Control Protocol)). It is to be understood that IP addresses that may be utilized for embodiments herein can include IP version 4 (IPv4) and/or IP version 6 (IPv6) IP addresses.

The flow record 231.1 can also include performance metrics 231.1c for the PDU session 204 traffic (e.g., UL throughput=25 kilobits per second (kbps), DL throughput=120 kbps, latency 102 msec (milliseconds, packet loss ratio=3%, etc.). The flow record 231.1 can also include flow data 231.1d that can be determined by the IP probe function, such as an application ID (AppID) for an application/application server with which the UE 202 is exchanging communications via the PDU session 204 (e.g., AppID: 450) and potentially an application type (AppType) for the application, such as AppType: Video, such that the application is determined to be a video streaming application. Other metrics, data, information, etc. that may be generated, determined, inferred, and/or the like can be included in a flow record; the flow record 231.1 is provided for illustrative purposes only and is not meant to limit the broad scope of embodiments herein.

UPF 224: The UPF 224 may operate to provide packet routing and forwarding operations for user data traffic and may also perform a variety of functions such as packet inspection, traffic optimization, Quality of Service (QoS), policy enforcement and user data traffic handling (e.g., to/from data network 280), and billing operations (e.g., accounting, etc.) for UE PDU sessions that can be anchored at the UPF 224.

UDM 232: The UDM is a subscriber database that may expose services via the Nudm interface/reference point. Privacy opt-in/opt-out data (e.g., indicating whether a subscriber has/has not consented to their subscriber data being utilized for analytic purposes), among other subscriber data or contexts, such as a subscriber ID, subscriber profile/subscription information, can be held/stored in the UDM 232.

AMF 226: The AMF 226 is a termination point for non-access stratum (NAS) signaling for a given UE, such as UE 202. For embodiments herein, the AMF 226 plays a key role as the interface into location calculations involving the LMF 250 and also for exposing UEC of a given UE, which can be obtained by the AMF 226 during registration of a UE, such as UE 202, to establish a connection with a gNB and the mobile network 200, through mobility events for the UE 202, and/or through any NAS signaling. The AMF exposes services via the Namf interface/reference point.

UEC can be referred to herein interchangeably as a UEC data structure. In at least one embodiment, UEC can include information stored in the Subscriber Identity Module (SIM) of a UE, such as subscriber ID, a Permanent Equipment Identifier (PEI) and/or International Mobile station Equipment Identity (IMEI) that can include a Type Allocation Code (TAC) that defines/identifies a manufacturer and a model of the UE for the subscriber.

Different identifiers for a subscriber can be utilized for a mobile network. In at least one embodiment, a subscriber ID can be a Generic Public Subscription Identifier (GPSI), such as Mobile Station International Subscriber Director Number (MSISDN). In at least one embodiment, a subscriber ID can also be a Subscription Permanent Identifier (SUPI) (for 5G) uniquely identifying a subscriber within a mobile network.

SMF 228: The SMF 228 manages subscriber PDU sessions within the mobile network 200. Through session establishment procedures for establishing a PDU session for a given UE, such as for establishing the PDU session 204 of UE 202, the SMF 228 can obtain subscriber/subscription information for the UE 202, such as the subscriber ID/SUPI for the subscriber corresponding to UE 202 from the UDM 232, for authorizing/authenticating the UE 202 to establish the PDU session 204.

Through embodiments herein, the SMF 228 is used to obtain the session management context (SMC) of a given subscriber having a given PDU session based on an IP address of the PDU session (the IP address assigned to the UE for the PDU session). SMC can be referred to herein interchangeably as an SMC data structure. In various embodiments, SMC can include any combination of a subscriber ID of a given subscriber (GPSI/SUPI), Quality of Service (QoS) information that is to be provided a PDU session that can be established for the given subscriber, PDU session ID, Data Network Name (DNN) for a PDU session, PDU session type information (e.g., IPv4, IPv6, Ethernet), UPF information, IP address assigned to the UE for a given PDU session (also referred to herein as the IP address for the PDU session), charging information, policy information, cell ID information identifying the radio node/cell to which a UE is currently connected (e.g., an NCGI for a gNB (for 5G) or an ECGI for an eNodeB (eNB, for 4G/LTE), and/or the like. Because the subscriber ID (GPSI/SUPI) is also stored in the SMF, it can be considered as being included in both SMC and UEC.

LMF 250: The LMF 250 operates to compute/calculate position information (also referred to herein as location information) for a given UE using a variety of methods, such as those described in 3GPP Technical Specification (TS) 38.305. Embodiments herein that provide for determining positioning (location) information for a given UE may be based on 3GPP procedures in the 5GC and location services (LCS) used for positioning, i.e., to determine a position of the given UE. In at least one embodiment, a given UE may assist in positioning operations performed by the LMF 250 by the UE (potentially continuously, or periodically) providing Global Navigation Satellite System (GNSS) data to assist with accurate positioning by the LMF 250. In various embodiments, location information for a UE can include Global Positioning System (GPS) coordinates, latitude and longitude information, combinations thereof, and/or the like representing a location of the UE. In various embodiments, location information for a UE can be used to compute velocity information indicating a speed and/or direction at which the UE may be moving (e.g., a vector that can be estimated from multiple (potentially consecutive) location measurements for a UE and their respective timestamps).

GMLC 252: The GMLC 252 is a functional entity that provides an interface for a client that may utilize positioning data, such as NWDAF 240, to initiate UE location queries towards the GMLC 252. The GMLC 252 uses the “Le” reference point and the mobile location protocol defined in Mobile Location Protocol 3.3, Open Mobile Alliance, 2009 and exposes services via the Ngmlc interface, as defined in 3GPP TS 29.515.

NWDAF 240: 3GPP TS 23.288 provides standards-based details for a 3GPP NWDAF, which can be used to collect data from entities of a mobile network in order to provide statistics and trend predictions derived from the collected data. In accordance with embodiments herein and with reference to FIG. 2C, the NWDAF 240 include standards-based functionality and may also include resolver logic 242, a mapping cache 243, anomaly logic 244, anomaly criteria storage 245 for storing anomaly criteria, and one or more databases, referred to herein as a ‘data lake’, shown in FIG. 2C as a data lake 246. Data lake 246 may serve as a repository for data regarding IP flows, such as flow records 231, analysis/analytic data generated by NWDAF 240 based on anomaly and/or RF/network impairment detection/identification, and/or any other data/information that may be obtained by, utilized by and/or generated by NWDAF 240 (e.g., any AI/ML modeling information, analysis, etc.).

During operation, resolver logic 242 may facilitate operations for resolving an IP address for a PDU session/UE to an SMC (SMC data structure) for the subscriber corresponding to the PDU session in which the process for resolving the IP address to the SMC is referred to herein as an ‘IPtoSMC’ process. As noted above, the SMC data structure can include the SUPI of the subscriber, among other information. Resolver logic 242 may also facilitate operations for resolving a SUPI for a subscriber to the UEC (UEC data structure) for the UE of the subscriber in which the process for resolving the SUPI to the UEC is referred to herein as ‘SUPItoUEC’ process. As noted above, the UEC data structure can include the IMEI/PEI for a UE, the NCGI/ECGI (cell ID) regarding a connection for the UE, and any other relevant UE specific data/information.

Various mappings/mapping information resulting from the IPtoSMC process (e.g., a mapping of a PDU session/UE IP address to the SMC/SUPI of a subscriber for the PDU session) and the SUPItoUEC process (e.g., a mapping of the SUPI of a subscriber to the UEC of the UE of the subscriber) can be held/stored within the mapping cache 243, which is a local cache, rapidly accessible by the resolver logic 242. The mapping information for mapping an IP address of a subscriber to SMC information for the subscriber and for mapping a SUPI of the subscriber to UEC corresponding to the subscriber's UE can be used to quickly update flow records received for the UE with SMC information (e.g., subscriber ID, such as SUPI) and UEC information (e.g., UE manufacturer and model, potentially cell ID, etc.) without having to perform the IPtoSMC and SUPItoUEC processes for each flow record.

Through the various resolver logic 242 processes or by querying mapping information for a subscriber/UE stored within mapping cache 243, the resolver logic 242 can obtain the SMC data structure or the UEC data structure for the subscriber/UE in order to add a corresponding subscriber ID (e.g., SUPI), UE manufacturer, UE model, and/or any other SMC/UEC data/information to the flow record of a given UE obtained by the NWDAF 240. Referring briefly to FIG. 2D, FIG. 2D is a diagram depicting an updated flow record 231.1′ including additional information that can be added to the flow record 231.1 by the NWDAF 240/resolver logic 242; specifically, a SUPI for the subscriber for UE 202, a manufacturer for UE 202, and a model for UE 202 that can be obtained by the resolver logic 242 via an IPtoSMC process and a SUPItoUEC process or via such information that can be stored via mapping cache 243.

For example, as shown in FIG. 2D, the updated flow record 231.1′, as can be updated by resolver logic 242, can include SMC information 231.1e, such as the SUPI for the subscriber of UE 202 (e.g., SUPI=301001123456789) and UEC information 231.1f, such as a manufacturer (mfgr) and model for UE 202 (e.g., UE Mfgr=MFG1, UE model=ModelABC). In at least one embodiment, other SMC information can be included in the flow record, such as the cell ID (NCGI or ECGI), of the radio node to which the UE 202 is connected. Other UEC information can also be included in the flow record, for example, UEC information that may be utilized by anomaly logic 244 for detecting/identifying RF and/or network impairments. Other updates can be provided for a UE flow record, as discussed in further detail below.

Further during operation, anomaly logic 244 may facilitate operations for determining an anomaly for a UE based on a comparison between anomaly criteria and performance metrics in flow record(s) for the UE. In accordance with embodiments herein, an initial anomaly determination can be made as to whether a UE may be experiencing an anomaly based on a comparison with the anomaly criteria such that, upon determining an anomaly for the UE, the flow record for the UE (stored in the data lake 246) can be updated to include an anomaly flag. The UE flow record can also be updated to include location information for the UE.

Anomaly criteria for detecting an anomaly for a given UE can be stored via anomaly criteria storage 245. The anomaly criteria can be considered as QoE criteria or QoE profiles that can include different performance metric values that can be used to determine, based on a comparison with performance metrics contained in UE flow record(s), whether an anomaly is being experienced by a given UE. In some embodiments, statistical analysis and/or machine learning (ML) operations can be performed by the NWDAF 240, via anomaly logic 244, in order to automatically update/adjust the anomaly criteria.

Anomaly criteria for detecting an anomaly for a UE can include a combination of QoE/performance metrics. As illustrated in FIG. 2C, in various embodiments, consider that example anomaly criteria 245a for detecting an anomaly can include threshold values for at least two performance metrics including, but not limited to, an UL throughput threshold value, a DL throughput threshold value, a latency threshold value, an UL throughput variation threshold value (for comparison with variations in UL throughput determined across multiple flow records), a variation threshold value for DL throughput (for comparison with variations in DL throughput determined across multiple flow records), a variation threshold value for latency (for comparison with variations in latency determined across multiple flow records), combinations thereof, and/or the like for any performance metrics that can be included in flow records generated by IP probe function 230. In some embodiments, one or more sets of rules can be defined that may indicate different types of anomaly criteria that may be grouped together/analyzed together to detect different types of anomalies.

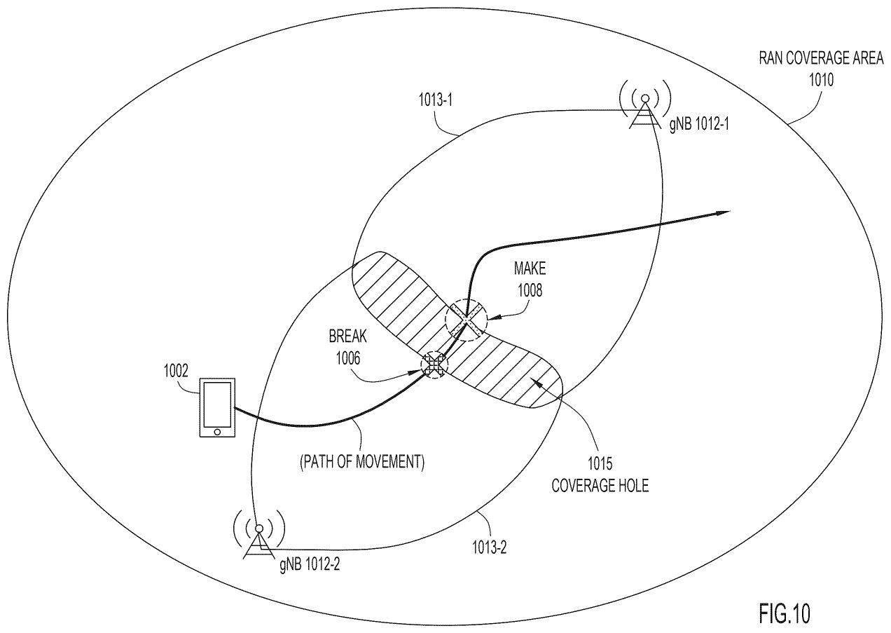

In one example, consider that anomaly criteria can include a DL threshold value set to 150 kbps and a latency threshold value set to 60 msec such that for any DL throughput less than 150 kbps and any latency greater than 60 msec, an anomaly is detected for a UE. Thus, in this example, an anomaly could be detected for UE 202 based on the flow record 231.1 indicating a DL throughput of 120 kbps (which is less than the threshold value of 150 kbps) and indicating a latency of 102 msec (which is more than the threshold value of 60 msec) such that anomaly logic can flag the UE 202 as experiencing an anomaly. For example, anomaly logic 244 can set an anomaly flag for the flow record to indicate an anomaly for the UE 202. The anomaly logic 244 can also initiate a UE location query towards GMLC 252 upon detecting an anomaly for the UE 202 in order to obtain a location of the UE 202 such that the UE location can also be added to the flow record for the UE 202. In at least one embodiment, other performance metrics/criteria such as tracking cell ID changes for a UE (signaling handovers for the UE) in combination with detach/re-attach information for the UE can be used to flag a UE as potentially experiencing an anomaly (e.g., for detecting coverage holes in a RAN, as discussed in further detail with reference to FIG. 10, below).

Referring briefly again to FIG. 2D, the updated flow record 231.1′ can be further updated by anomaly logic 244 to include an anomaly flag 231.1g that can be set to a value of ‘TRUE’ in this example (or set to 1 or the like) to indicate that an anomaly has been detected for UE 202. In at least one embodiment, the anomaly flag could be set to a value of ‘FALSE’ (or set to 0/null or the like) if no anomaly were detected for the particular flow record for the UE or the flow record may not be updated to include the anomaly flag 231.1g altogether.

The anomaly logic 244 can also add UE location information 231.1h into the updated flow record 231.1′ (e.g., Loc: X-Y) which can identify the location of UE 202. In essence, the location of the UE included in the updated flow record 231.1′ can correspond to the location at which the UE experienced an anomaly. In various embodiments, location information for a UE can include Global Navigation Satellite System (GNSS) coordinates (such as Global Positioning System (GPS) coordinates), latitude and longitude information, combinations thereof, and/or the like representing a location of the UE as may be calculated by the LMF 250/GMLC 252. In various embodiments, location information for a UE can include velocity information indicating a speed and/or direction at which the UE may be moving (e.g., a vector) as may be calculated by the LMF 250/GMLC 252.

In some embodiments, RF data can be added to a flow record of a UE for which an anomaly is detected in which the RF data can correspond to RF data, such as received signal strength information (RSSI), etc. corresponding to the location of the UE as included in the updated flow record. For example, RF data 231.1h can be added to the updated flow record 231.1′ indicating an RSSI of −40 decibels per milliwatt (dBm) that can be determined for RAN 210 at the location (Loc: X-Y) at which the UE 202 was located for the flagged anomaly. In various embodiments, RF data can be determined through RAN probes and/or detailed RF coverage maps (e.g., RF map 270) that can be obtained by raytracing.

Flow records/updated flow records stored in the data lake 246 can be further processed/analyzed by the anomaly logic 244 to determine whether an anomaly detected for the UE 202, and potentially anomalies for other UEs also occurring at the same location/within a threshold vicinity of the location of the UE 202, correspond to an RF impairment at a location/locations of the UE 202 within the RAN 210 or correspond to a network impairment.

Additional operations that may be performed by the NWDAF 240 and/or additional details for the operations outlined above are discussed in further detail herein, below.

NRF 236: The NRF 236 may facilitate resolving an IP address of other application or network functions. For example, the NRF 236 can be used to determine the serving SMF of a given PDU session based on an IP address for that PDU session/UE.

NEF 238: The NEF 238 can expose data (e.g., to one or more 3^{rd} party apps 274) that can be used for additional analytics and/or for exposing per-subscription QoE information.

In some instances, embodiments herein may utilize location services via NEF 238 exposure or using roaming network location services as described in § 4.2.2 of 3GPP TS 23.273. To simplify, it may be assumed that the home network (HN) and the serving network (SN) are the same. To support different use cases, in some embodiments, the IP probe function 230 can also be in a home network without serving a RAN. Such an embodiment may involve location services via NEF 238 exposure or using roaming network location services as described in § 4.2.2 of TS 23.273.

Dashboard 272: The dashboard 272 can be any GUI/GUIs that can be provided via one or more computing devices/displays to render data analytics using applications that process the NWDAF 240 data for visualization and rendering of data.

RF Map 270/RAN data 214: In FIG. 2A, the RF map 270 and/or RAN data 214 represent mechanisms through which different types of RF data can be provided to NWDAF 240 in which such RF data can be used for determining RF impairments for one or more locations of RAN 210, for providing visualizations/data corresponding to RF impairments determined for one or more locations of RAN 210, and/or the like. In various embodiments, RF data can include signal strength information at one or more RF carriers, potentially with positioning information for different signal strength information, RF maps/map information constructed asynchronously through a variety of methods that include using drive tests, using UE-based MDT, collecting RAN OAM data (if available), and/or through detailed RF modeling, any of which can be used to enrich flow records maintained/updated via the data lake 246 of the NWDAF 240. In at least one embodiment, trace ports in one or more of gNBs 212-1-212-N can be used for obtaining timestamped RF data synchronously from RRC signaling exchanged between one or more UEs within the RAN 210 and the gNB(s), such as between UE 202 and gNB 212-1.

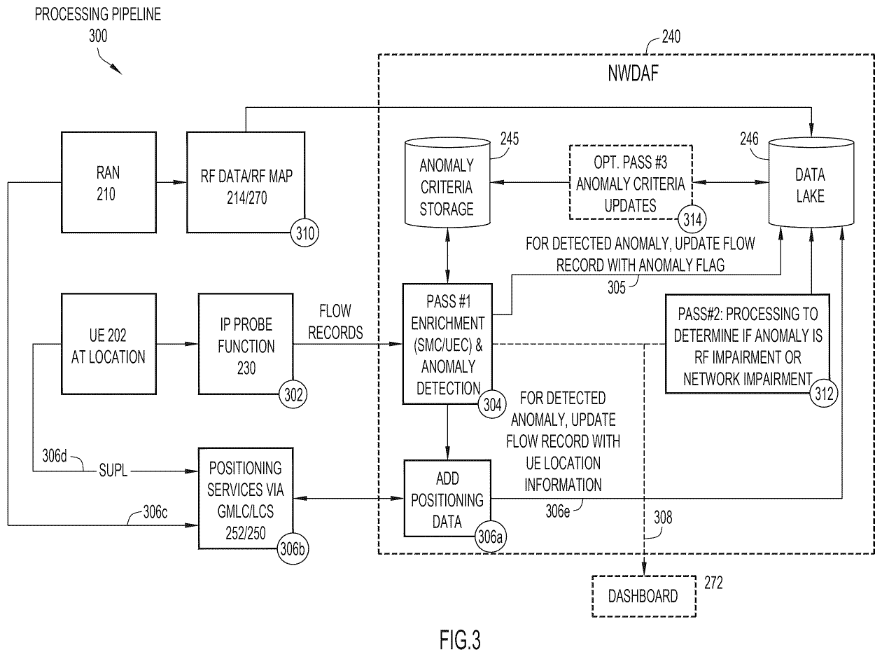

FIG. 3 illustrates example details for a processing pipeline 300 for various operations that may be performed the mobile network 200 of FIG. 2A to facilitate identifying RF impairments in the RAN 210, according to various example embodiments. FIG. 3 illustrates various elements of mobile network 200 with reference to various operations that can be performed via the processing pipeline 300, including UE 202, RAN 210, RF data 214 (e.g., RF measurement data obtained from gNB 212-1) and RF map 270, IP probe function 230, and various elements of NWDAF 240, including anomaly criteria storage 245 the data lake 246. Resolver logic 242, mapping cache 243, and anomaly logic 244 are not shown in FIG. 3 but may be referenced in discussing features associated with the processing pipeline 300.

As discussed above, through operation of the mobile network 200, the NWDAF 240 is populated with timestamped flow records originating in the IP probe function 230 and enriched with subscriber and UE data (e.g., SMC and UEC) by the NWDAF 240 via resolver logic 242 and the NWDAF 240 then performs various anomaly detection operations using the enriched flow record to determine if an anomaly is detected for the UE (via anomaly logic 244).

Some processes may be performed online/synchronously or in RT/near-RT, for example to capture SMC and UEC, for updating a UE flow record and to capture the positioning data when utilized. Some processes may be performed offline/asynchronously, for example, through pre-processing operations, post-processing operations, or through batch processing operations.

For instances in which an anomaly is detected for a UE (based on a comparison between performance metrics included a flow record for the UE to anomaly criteria), the NWDAF 240, via anomaly logic 244, updates the flow record for the UE to include an anomaly flag (e.g., anomaly: TRUE or the like). The flow record for the UE is also updated by the NWDAF 240 to include a location of the UE. Location information can be added into a flow record of a UE either online/synchronously when an anomaly is detected for the UE or offline/asynchronously (if the location has been stored synchronously in the data lake 246), for example, upon detecting multiple anomalies for the UE across multiple flow records.

Thus, some processes may be performed online or offline, or a combination thereof, such as adding UE positioning information and/or adding RF data to a flow record of a UE (or flow records of multiple UEs).

In some instances, location resolution operations may be computationally expensive such that they may involve coordination/signaling/communications among multiple entities/systems of mobile network, such as GMLC 252 and LMF 250. Thus, in some embodiments, location information may be obtained for a UE upon detecting multiple anomalies for the UE across multiple flow records spanning a period of time (e.g., a few seconds to several minutes) rather than upon detecting a single anomaly for the UE via a single flow record, such that location information for the UE can be added to all flow records spanning the period of time (using the timestamp contained in each flow record to determine the appropriate flow records in which to include the UE location information. In some instances, UE flow records can be stored into “bins” defined over time ranges within data lake 246.

Similar operations could be performed upon determining/detecting similar anomalies for multiple UEs within a period of time (but without knowing the location of the UEs), such as detecting decreased DL throughput and increased latency for a group of UEs in which case location resolution processes could be initiated for the group of UEs to determine whether or not the UEs might be in the same location or within a threshold vicinity of each other in order to determine a potential RF impairment at the location. However, if the UEs are determined to be at different locations following the location resolution process but experiencing the same/similar anomalies, NWDAF 240 could determine that a network impairment is being experienced by the UEs.

Similar operations could be performed for one or more UEs for adding RF data to the flow record(s) of the UE(s) through online or offline processing. For example, in some instances RF measurements for RAN 210 and/or an RF map/updated RF map 270 for RAN 210 may be made available to the NWDAF 240/data lake 246 on a periodic basis such that when such information is made available to the NWDAF 240, flow records for UE(s) at location(s) corresponding to the RF data can be updated accordingly.

Thus, it is possible to perform a location lookup and/or provide RF data for every flow record of every UE and/or perform location lookups at different times, periodically, based on different lookup criteria, etc. (e.g., every N flow records, for a group of flow records indicating a similar anomaly over a period of time, etc.). The choice of providing location information and/or RF data online or offline may be driven by economics/affordability of computational resources, with an advantage of adding such information for every flow record (of every UE) being a richer datastore of flow records including location and, potentially, RF data for every UE.

The data lake 246 can therefore provide a basis for performance/impairment analysis via the NWDAF 240/anomaly logic, potentially triggering performance/impairment analysis for one or more UE flow records when new/updated data (e.g., RF data, location data, etc.) is made available to and/or otherwise ingested by the NWDAF 240. On the other hand, analysis of data deposited in the NWDAF 240/data lake 246 can also be performed offline as a post-processing step in some embodiments. A good example of this is the analysis to discover RF impairments that may involve the analysis/statistics of multiple RF measurements as described herein, below.

Processing Pipeline

With reference to FIG. 3, consider for the processing pipeline 300 that UE 202 is at a location of RAN 210 and exchanges communications with data network 280 via PDU session 204 that traverses the user plane of mobile network 200 such that the IP probe function 230 generates flow records for UE 202, as shown at 302 that are fed to the NWDAF 240. The IP probe function 230 is deployed to access the user plane (GTP-u encapsulated packets or non-GTP-u encapsulated packets) via direct interception and/or via a mirror. The flow records are tagged a 5-tuple that includes the IP address for the PDU session 204, which is the IP address for UE 202 for the PDU session 204. Each flow record also includes a timestamp, performance metrics, and potentially other flow data that can be determined/inferred by the IP probe function 230. Thus, the flow records log performance information and other data that may be inferred through IP probe function 230 analysis.

In some instances, persistent long-lived adaptive bit-rate video flows may be identified, for example, through flow data that can be included in flow records by the IP probe function. Flows tagged as long-lived may be preferred for RF/network impairment analysis because they are expected to be continuously active/involve persistent delivery. For example, for long-lived flows, such as video streaming flows, as the play-out buffer in a UE is depleted, it is replenished with additional content, thereby maintaining continuous activity for the UE PDU session.

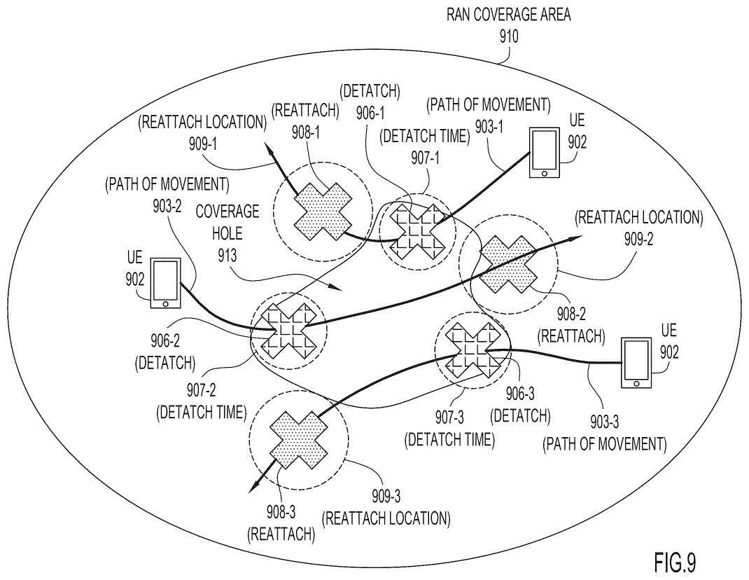

In at least one embodiment, the operations for processing pipeline can broadly be performed utilizing a number of processing ‘passes’ that can be performed by the NWDAF 240, as follows:
(1) Pass #1 (304) (online/synchronous processing for enriching flow records with SMC and UEC, anomaly detection, and possibly UE location and/or RF data; potential offline/asynchronous processing for UE location and/or RF data)
   Flow records are enriched with a subscriber ID (SUPI) or GPSI, such as MSISDN (SUPI can be used to retrieve a GPSI such as MSISDN), obtained from SMC and UE data (manufacturer and model information) obtained from UEC. Flow records are stored via data lake 246 and can be updated throughout various processing performed by the NWDAF 240.
   Anomaly logic 244 looks for flows that breach or satisfy anomaly criteria (stored via anomaly criteria storage 245). In some embodiments the anomaly criteria can include base criteria manually configured by a network operator and/or in some embodiments the anomaly criteria can be generated and/or updated through analysis performed by the NWDAF 240 in Pass #3 (314), discussed below.
   Upon detecting an anomaly (potentially an RF impairment) for UE 202 based on a comparison between flow record performance metrics and the anomaly criteria, NWDAF 240 updates the flow record to include an anomaly flag set to indicate an anomaly for the UE, as generally shown at 305.
   The NWDAF 240 also updates the flow record with location information for the UE 202 (broadly positioning data), as shown at 306e. As noted above, this process can be performed online or offline. For the present example, consider that location information for the UE 202 is to be added to the flow record in an online manner such that NWDAF 240/anomaly logic 244 initiates a location resolution procedure for UE 202, as generally illustrated at 306a and 306b, involving GMLC 252, LMF 250, information obtained from RAN 210/gNB 212-1 (306c) and, for instances in which UE 202 is GNSS-enabled, the location resolution procedure can include positioning information obtained from UE 202, as shown at 306d.
   In some instances, enriched flow records for UE 202 can be rendered in near-RT on dashboard 272, as shown at 308, as well as being populated in the data lake 246.
   In some instances, data in the form of RF map 270 (coverage map) and/or RF data from RAN 210 can also be used to populate the NWDAF 240/data lake 246, as shown at 310. Synchronous acquisition of RF conditions for the UE 202 is possible if the IP probe function 230 is capable of tapping into a RAN trace port. RF parameters can also be acquired from RRC message monitoring. It is also possible to acquire RAN data from an OAM system. Synchronous acquisition of RAN data can include acquiring UE state of carrier aggregates (CA), UE state of dual connectivity (DC), handover (HO) operations/steps, and/or the like.
   Although not shown in FIG. 3, in some instances, network data, such as OAM data collected by one or more network elements, one or more network controllers, and/or the like can also be fed into the NWDAF 240/data lake 246 to aid in RF/network impairment analysis that can be performed by the NWDAF 240 (e.g., via anomaly logic 244).
(2) Pass #2 (312) (online/synchronous processing for identifying/detecting RF/network impairments, offline/asynchronous processing identifying/detecting RF/network impairments, or a combination thereof)
   NWDAF 240, via anomaly logic 244, performs processing, including statistical analysis, AI/ML analysis, combinations thereof, and/or the like (potentially performed over many samples/flow records) to determine whether an anomaly detected for a UE (or a group of UEs) may correspond to an RF impairment (e.g., a drop in UL and DL throughput, etc.) at a location (or area) of RAN 210 or may correspond to a network impairment.
   In at least one embodiment, an RF impairment may be distinguished from a network impairment in that multiple anomalies detected for a given UE (or multiple UEs) that occur at a particular location (or within a particular area) of RAN 210 can be identified (potentially in combination with RF data for the RAN and/or any other data) as an RF impairment within the RAN 210, whereas multiple anomalies detected for a given UE (or a group of UEs) that are detected at different locations or that may occur irrespective of location, can be identified (potentially in combination with network data and/or any other data) as a network impairment involving user plane traffic handling/forwarding/routing within the mobile network 200. Additional details regarding example techniques for detecting RF/network impairments are discussed below with reference to FIGS. 9 and 10.
   In some instances, UE manufacturer and model information can be useful for detecting/identifying problems with particular manufacturers/particular devices regarding certain RF impairments that may be experienced in RAN 210.
   Pass #2 can be performed in a synchronous manner (online) to facilitate RT or near-RT identification of RF/network impairments, can be performed in an asynchronous manner (offline) through pre-processing and/or post-processing, and/or can be performed through any combination of online/offline processing through which anomalous enriched data can be analyzed by the NWDAF 240/anomaly logic 244 uncover possible RF and/or network impairments.
   In some instances, analysis, detected RF/network impairments, data, etc. can be rendered in near-RT on dashboard 272, as well as being populated in the data lake 246.
(3) Pass #3 (314, optional, offline/asynchronous processing)
   In some embodiments, NWDAF 240/anomaly logic 244 can generate and/or update anomaly criteria for conforming traffic. The purpose of this stage is to improve anomaly detection. For example, based on statistical analysis, AI/ML analysis, etc., the anomaly criteria can be automatically adjusted.

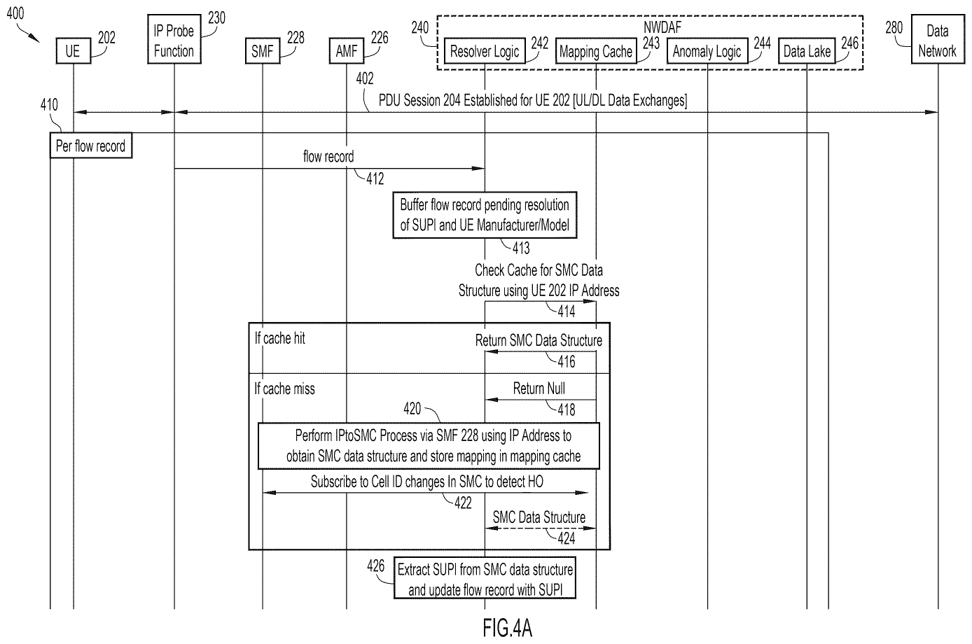

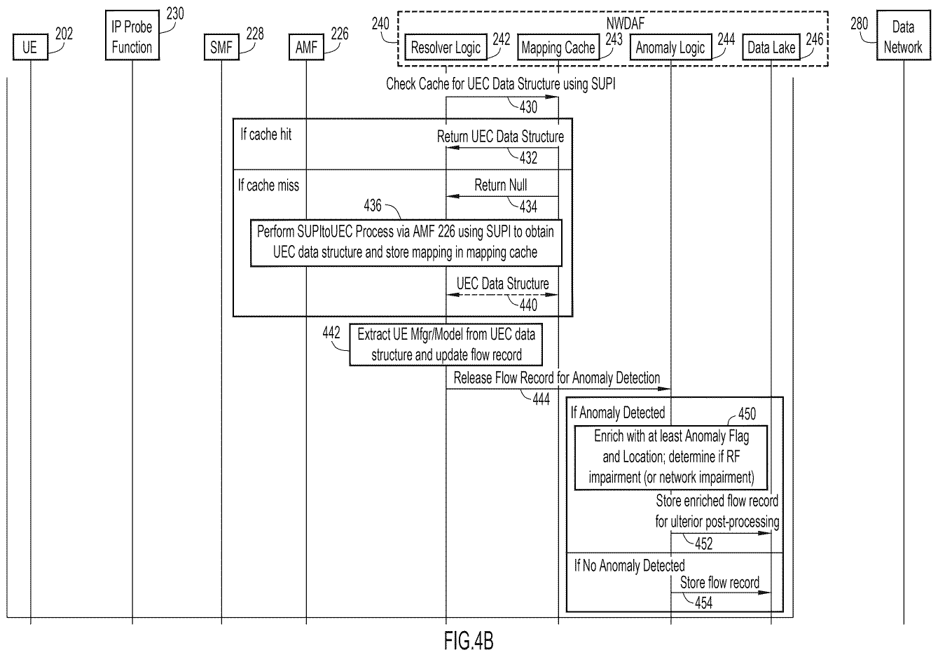

FIGS. 4A and 4B are a call flow 400 depicting example operations that can be utilized to collect data that can be used to identify RF impairments for mobile network 200, according to an example, embodiment. FIGS. 4A and 4B include UE 202, IP probe function 230, SMF 228, AMF 226, data network 280, and NWDAF 240 including resolver logic 242, mapping cache 243, anomaly logic 244, and data lake 246.

Broadly, FIGS. 4A and 4B illustrate example details for the flow record processing pipeline, as discussed above, that involve enriching flow records and populating the NWDAF 240 data lake 246. Anomaly detection and identification RF/network impairments can be performed by the NWDAF 240, via anomaly logic 244, utilizing the flow records. Broad anomaly detection/impairment signaling features that can be realized via mobile network 200 are also shown in FIG. 4B. As noted herein, flow records collected in real-time can be rendered on a dashboard as well.

As shown at 402, consider that UE 202 has established PDU session 204 through which UL/DL communications can be exchanged between UE 202 and data network 280 (e.g., an app/app server within data network 280) via the user plane of mobile network 200.

Before discussing operational features of FIGS. 4A and 4B, consider various privacy aspects of embodiments herein. Privacy is an important consideration, and rules will vary depending on jurisdiction and use case. There is a broad variety of use cases where a business outcome unreservedly involves location consumption. For example, cellular IoT services may involve the conveyance of locations information to an enterprise (dispatching, tracking, home deliveries, medical devices, drones, etc.). In these business-oriented use cases, location privacy may be outweighed by the desire of a paying enterprise customer to know the location of a mobile resource. Consumer use cases, on the other hand, might consider exposing positioning information and flow records from which data, such as different applications that a subscriber has used and/or different internet sites that a subscriber has visited, can be extracted to be an intrusion on privacy.

Thus, to address privacy considerations, one approach may be to use the subscriber database, such as the UDM 232 (or a Home Subscriber Server (HSS) for 4G/LTE), where all per-subscriber policies are held to include an indication of opt-in or opt-out status regarding whether subscriber location and flow records (broadly, subscriber data) can be used for analytics as discussed for embodiments herein. Through such an approach, obtaining opt-in/opt-out status for a subscriber can be performed when collecting subscriber identity (with GPSI such as an MSISDN, which is associated in a one-to-one manner with a given SUPI of a subscriber) for a particular flow record, as well as any other data that may be exposed/included in the flow record. Such an approach provides the flexibility to deal with a broad variety of regulatory environments.

With reference to FIGS. 4A and 4B, various per-flow record operations 410 are now discussed. For example, as shown at 412, consider that a flow record (e.g., flow record 231.1) is generated by IP probe function 230 for the UE 202 mobile network traffic/packet flow that includes a timestamp, 5-tuple information (including the PDU session 204/UE 202 IP address), and at least performance metrics for the mobile network traffic in which the flow record is forward to/obtained by the NWDAF 240 resolver logic 242.

As shown at 413, resolver logic 242 buffers the flow record pending resolution of the UE 202 IP address to SMC to obtain the SUPI for the subscriber of UE 202 and resolution of the SUPI to UEC to obtain the manufacturer and model of UE 202.

As shown at 414, resolver logic 242 performs a check on the mapping cache 243 to determine if a mapping of the UE 202 IP address to the SMC data structure for the subscriber is stored within the mapping cache 243 by querying the mapping cache using the UE 202 IP address.

As shown at 416, if there is a cache hit (a mapping for the IP address to the SMC data structure is stored within mapping cache 243), the query returns the SMC data structure for the UE 202 subscriber.

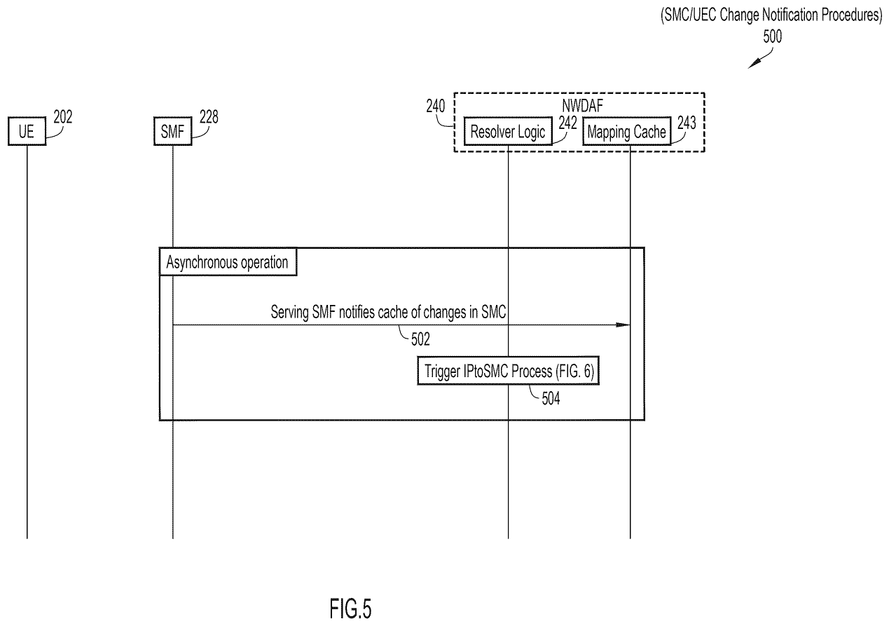

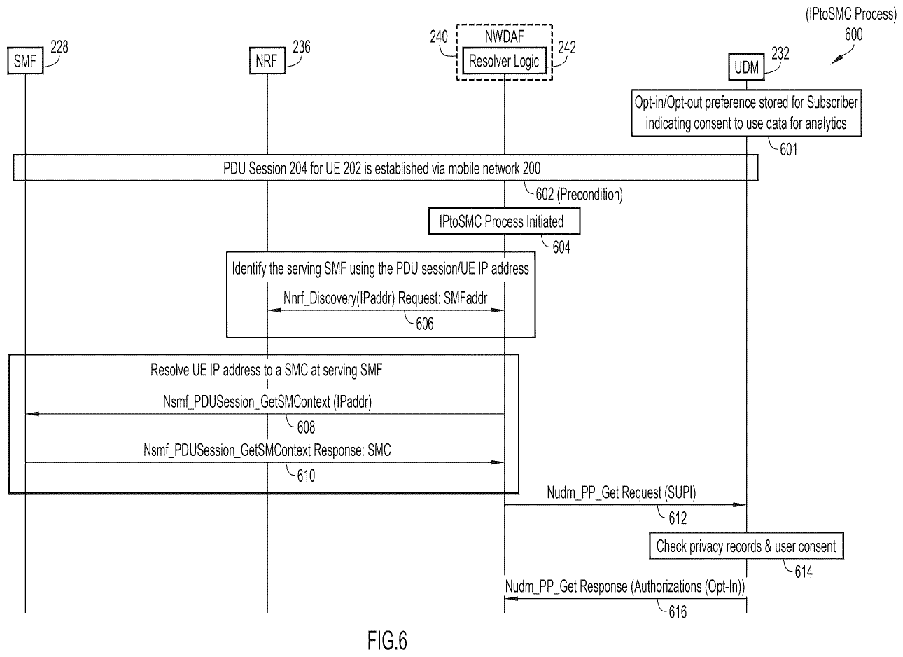

Otherwise, as shown at 418, if there is a cache miss, the query returns a null indication (or other similar indication indicating that no mapping to an SMC for the UE IP address is contained within the mapping cache 243), and the resolver logic 242 initiates the IPtoSMC process via SMF 228, as shown at 420, using the IP address to obtain the SMC data structure and update the mapping cache 243 with an IP address to SMC data structure mapping for the subscriber. Details for the IPtoSMC process are discussed below with reference to FIG. 6.

As shown at 422, the resolver logic 242 can subscribe to receive notifications from the SMF 228 for changes in the SMC for the UE 202 PDU session 204. For example, resolver logic 242 can subscribe to receive notifications regarding any changes in the cell ID (NCGI or ECGI) to which the UE 202 may be connected for the PDU session 204. The cell ID (NCGI or ECGI), which is a part of the SMC for UE 202, may change owing to user mobility. In this case, the resolver logic 242 subscribes to changes in the cell ID. When such a change is notified to the resolver logic 242, a handover (HO) has taken place for UE 202 and the resolver logic 242 can obtain updated SMC for the UE 202, as discussed below for FIG. 5.

As shown at 424, in one instance the resolver logic 242 can obtain the SMC data structure from the mapping cache 243 following the IPtoSMC process, however, in another instance, the resolver logic 242 can simply buffer the SMC data structure obtained through the IPtoSMC process.

Following either a cache hit or a cache miss, as shown at 426, the resolver logic 242 can extract the SUPI from the SMC data structure and update the flow record for UE 202 to include the SUPI.

Moving to FIG. 4B, as shown at 430, resolver logic 242 performs a check on the mapping cache 243 to determine if a mapping of the SUPI of the subscriber to the UEC data structure for the UE 202 of the subscriber is stored within the mapping cache 243 by querying the mapping cache using the SUPI for the subscriber.

As shown at 432, if there is a cache hit (a mapping of the SUPI to the UEC data structure is stored within mapping cache 243), the query returns the UEC data structure for the UE 202.

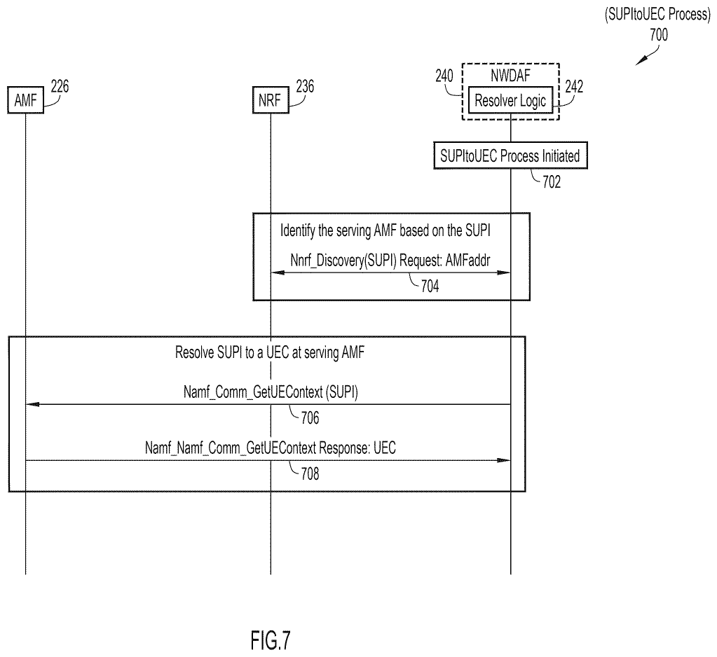

Otherwise, as shown at 434, if there is a cache miss, the query returns a null indication (or other similar indication indicating that no mapping to a UEC for the SUPI is contained within the mapping cache 243), and the resolver logic 242 initiates the SUPItoUEC process via AMF 226, as shown at 436, using the SUPI to obtain the UEC data structure and update the mapping cache 243 with a SUPI to UEC data structure mapping for the subscriber/UE 202. Details for the SUPItoUEC process are discussed below with reference to FIG. 7.

As shown at 440, in one instance the resolver logic 242 can obtain the UEC data structure from the mapping cache 243 following the IPtoSMC process, however, in another instance, the resolver logic 242 can simply buffer the UEC data structure obtained through the SUPItoUEC process.

Following either a cache hit or a cache miss, as shown at 442, the resolver logic 242 can extract the UE 202 manufacturer and model from the UEC data structure and update the flow record accordingly. As shown at 444, the resolver logic 242 can then release the flow record to anomaly logic 244, which can perform initial anomaly detection on the flow record based on the anomaly criteria.

As generally shown in FIG. 4B, in at least one embodiment at 450, if an anomaly is detected for the UE 202 based on the performance data included in the flow record, the anomaly logic 244 can enrich the flow record to the anomaly flag set to TRUE and can include the location of UE 202 (via a location resolution process involving GMLC 252 and LMF 250) in order to perform further analysis to determine if the anomaly corresponds to an RF impairment within RAN 210.

For example, if capacity on the SBA 260 exists, positioning data and, if available, RF data can be added to the flow record. Although not shown in FIG. 4B, the flow record can also be used to render near-RT performance on dashboard. If no capacity exists on the SBA 260 to support online location resolution, the anomaly flag set to TRUE can still be inserted into the flow record for further processing at a later time.

As shown at 452, the enriched flow record can also be stored via data lake 246 for additional post-processing. If no anomaly is detected for the UE 202, the flow record is not enriched with location information for the UE but can still be stored in the data lake 246, as shown at 454.

Referring to FIG. 5, FIG. 5 is a call flow 500 depicting notify procedures and operations associated therewith that can be performed based on updates that may occur for SMC information for a given subscriber/UE, according to an example embodiment.

FIG. 5 illustrates UE 202, SMF 228, and NWDAF 240 including resolver logic 242 and mapping cache 243.

SMC for a given subscriber/UE may change based on a cell ID change for the UE and/or an SMF change for the UE, for example, due to a handover of the UE from one gNB to another gNB. Thus, the SUPI and the PEI for a UE may change very little. By contrast, the NCGI may change much more frequently. Subscribe/notify procedures in the SBA will assist in monitoring changes.

When SMC changes for a given subscriber/UE, a notification procedure can be performed, as illustrated in FIG. 5, for any subscriptions initiated by the NWDAF 240 towards a given SMF handling a PDU session for a given subscriber (e.g., initiated towards SMF 228 for a PDU session of UE 202, as shown at 422 of FIG. 4A).

Broadly, the notification procedures illustrated in FIG. 5 can be used to alert the NWDAF 240 resolver logic 242 and mapping cache 243 that an IP address to SMC mapping for a given subscriber/UE mapping for a given subscriber is not current and needs to be updated, for example, if UE 202 has performed a handover from one gNB to another gNB, triggering an update in the cell ID and potentially the SMF serving the PDU session for the UE, both of which are maintained in the SMC for the UE. The SMF serving a UE PDU session may also change due to inter-PLMN mobility (e.g., between different PLMNs). The notification procedures as illustrated in FIG. 5 can be performed asynchronously during operation of mobile network 200; for example, when updates occur to SMC for a given subscriber/UE.

As shown at 502, the SMF 228 (handling a PDU session for UE 202, in this example) can asynchronously notify the mapping cache 243 via the resolver logic 242 regarding any changes in the PDU session support for a given PDU session of UE 202 handled by SMF 228.

In one example, the IP address for the PDU session might have changed, which can cause SMF 228 to notify the mapping cache regarding the IP address update for the PDU session.

In another example, the SMF of record (serving the PDU session) might cease to be the serving SMF for a given UE 202 PDU session (e.g., SMF 228 in this example), such as if a handover of the UE 202 from one gNB to another gNB occurs and causes an SMF change, if a maintenance procedure occurs causing a change in the SMF serving the PDU session, or the like.

Upon obtaining an indication of a change in the SMC for UE 202, the resolver logic 242, as shown at 504, can trigger an IPtoSMC process (as shown in FIG. 6) to obtain the updated SMC, which may include identifying a new serving SMF for the PDU session to update the mapping of the PDU session IP address to the SMC/SUPI of the subscriber for the PDU session stored via mapping cache 243. Through the IPtoSMC process, the mapping cache 243 can be refreshed with the most current mapping and network location of the current SMF (where the subscriber's session context resides).

FIG. 6 is a call flow 600 depicting operations for resolving an IP address for a PDU session to SMC for a given subscriber/UE, referred to herein as the IPtoSMC process, to obtain at least a subscriber identifier or SUPI for the given subscriber, according to an example embodiment. FIG. 6 includes SMF 228, NRF 236, resolver logic 242 of NWDAF 240, and UDM 232. As a precondition for the operations for FIG. 6, it is assumed that the PDU session 204 for UE 202 is established via mobile network 200, as shown at 602.

As discussed above (e.g., at least for operations 418 and 420 of FIG. 4A), when an PDU session/UE IP address obtained by the resolver logic 242 via a flow record (from the 5-tuple in the flow record) is determined, based on a query toward the mapping cache 243 using the IP address, to not be stored in an IP to SMC mapping in the mapping cache 243, an IPtoSMC process as shown in FIG. 6 can be initiated or invoked by the resolver logic 242 to obtain the SMC data structure from the SMF serving the session for the UE corresponding to the PDU session/UE IP address. Resolving a UE IP address to an SMC (and SUPI) can involve a lookup into the SMF serving the PDU session to obtain the entire SMC data structure for the PDU session.

Consider various operations that can be performed by resolver logic 242 regarding the subscriber/session of UE 202 for the IPtoSMC process shown in FIG. 6. As shown at 604, the IPtoSMC process can be initiated by the resolver logic 242, for example, based on obtaining an indication from the mapping cache 243 that no mapping exists for the IP address for the PDU session 204/UE 202 for which the resolver logic 242 has queried the mapping cache 243.

As shown at 606, the resolver logic 242 can obtain an IP address of the SMF (‘SMFaddr’ in FIG. 6) that is currently serving the PDU session 204, SMF 228 in this example, by performing a query on the NRF 236 using the IP address for the PDU session 204/UE 202 (e.g., using a 3GPP ‘Nnrf_Discovery’ query including the PDU session 204/UE 202 IP address, ‘IPaddr’ in FIG. 6) in which the NRF 236 returns the IP address of SMF 228 (SMFaddr) based on the query.

Moving to 608 and 610, the resolver logic 242 can use the SMF 228 IP address (SMFaddr) to identify and perform a direct query to the (serving) SMF 228 using the IP of the PDU session 204/UE 202 (IPaddr) (e.g., using a 3GPP ‘Nsmf_PDUSession_GetSMContext’ query including the PDU session 204/UE 202 (IPaddr)) in order to obtain the SMC data structure from the SMF 228 (e.g., via a 3GPP ‘Nnsmf_PDU_Session_GetSMContext’ response including the SMC data structure for the PDU session 204 of the subscriber).

As noted above, privacy concerns (for using subscriber data for analytics) may be addressed by using a subscriber database, such as the UDM 232 (or an HSS for 4G/LTE), where all per-subscriber policies are held to include an indication of opt-in or opt-out status regarding whether subscriber location and flow records (subscriber data) can be used for analytics. Such an approach is illustrated in FIG. 6. For example, as shown at 601, consider that UDM 232 includes an Opt-in indication indicating that the UE 202 subscriber has consented to the use of their data (e.g., identity, location, etc.) for analytical purposes.

In at least one embodiment, upon obtaining the SMC data structure for the PDU session 204, the resolver logic 242, as shown at 612, can perform a query towards the UDM 232 using the subscriber's SUPI (extracted from the SMC data structure) to confirm whether the subscriber has consented to the use of their data for analytical purposes (e.g., using a 3GPP ‘Nudm_PP_Get_Request’ query including the SUPI). As shown at 614, the UDM 232 can check the privacy records and user consent regarding use of their data for analytical purposes. In this example, as noted above, consider that the subscriber has consented to the use of their data such that the UDM 232 responds to the query with an indication that the subscriber has consented to the use of their data for analytical purposes (e.g., using a “Nudm_PP_Get_Response’ message including authorizations for the subscriber indicating their ‘Opt-in’ status regarding use of their data for analytical purposes), as shown at 616.

Although illustrated after performing the query to obtain the SMC for the subscriber, in some embodiments, the check for subscriber consent could be performed during PDU session establishment for a subscriber/UE. In some embodiments, the check for subscriber consent could also be checked upon initiating the IPtoSMC process (e.g., at 604) by the resolver logic 242 for a given PDU session/UE IP address contained in a flow record.

The SMC data structure can be stored via mapping cache 243 and any SMC data/information can be extracted from the SMC data structure for updating UE flow record(s) in accordance with embodiments herein, for example, as discussed above with reference at least to FIG. 4A.

FIG. 7 is a call flow 700 depicting operations for resolving a SUPI of a subscriber to UEC, referred to herein as the SUPItoUEC process, to obtain at least UE manufacturer and UE model information for a given UE corresponding to a given subscriber identified by the SUPI, according to an example embodiment. FIG. 7 includes AMF 226, NRF 236, and resolver logic 242 of NWDAF 240

As discussed above, when a subscriber ID, such as a SUPI, extracted by the resolver logic 242 from an SMC data structure (obtained from a serving SMF via the IPtoSMC process or via a query towards mapping cache) is determined to not be stored in a SUPI to UEC mapping in the mapping cache 243, a SUPItoUEC process as shown in FIG. 7 can be initiated or invoked by the resolver logic 242 to obtain the UEC data structure from the AMF serving the RAN connection/terminating NAS signaling for the UE corresponding to a given SUPI (subscriber).

Consider various operations that can be performed by resolver logic 242 regarding UE 202 for the SUPItoUEC process shown in FIG. 7. As shown at 702, the SUPItoUEC process can be initiated by the resolver logic 242, for example, based on obtaining an indication from the mapping cache 243 that no mapping exists for the SUPU of the subscriber of UE 202 for which the resolver logic has queried the mapping cache.

As shown at 704, the resolver logic 242 can obtain the IP address of the AMF (‘AMFaddr’ in FIG. 7) serving the UE 202 RAN 210 connection, AMF 226 in this example, by performing a query on the NRF 236 using the SUPI of the subscriber of UE 202 (e.g., using a 3GPP ‘Nnrf_Discovery’ query including the SUPI) in which the NRF 236 returns the IP address of AMF 226 (AMFaddr) based on the query.

Moving to 706 and 708, the resolver logic 242 can use the AMF 226 IP address (AMFaddr) to identify and perform a direct query to the serving AMF 226 using the SUPI of the UE 202 subscriber (e.g., using a 3GPP ‘Namf_Comm_GetUEContext’ query including the SUPI) in order to obtain the UEC data structure from the serving AMF 226 (e.g., via a 3GPP ‘Namf_Comm_GetUEContext’ response including the UEC data structure for UE 202 RAN 210 connection). The UEC data structure can then be stored via mapping cache 243 and any UEC data/information can be extracted from the UEC data structure for updating UE flow record(s) in accordance with embodiments herein, for example, as discussed above with reference at least to FIG. 4B.

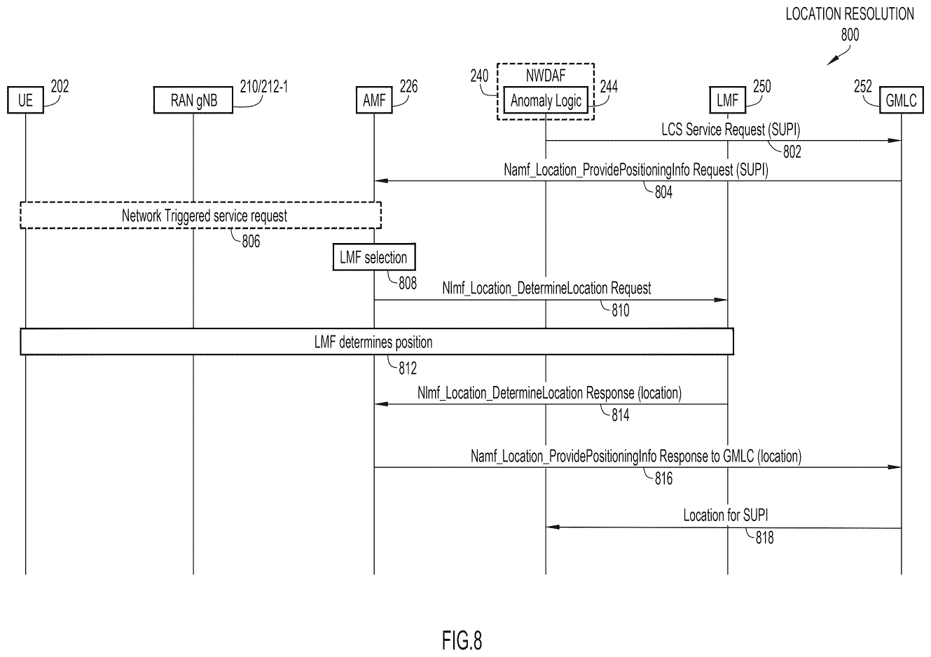

FIG. 8 is a call flow 800 depicting operations for resolving a location of a given UE, according to an example embodiment. As discussed for embodiments herein, location information for a UE can be added to flow record(s) of the UE upon detecting an anomaly for the UE based on the flow record(s) (e.g., detecting an anomaly for the UE based on performance metrics included one flow record for the UE or detecting anomalies for the UE based on performance metrics included in multiple flow records for the UE over a period of time or the like). FIG. 8 includes UE 202, RAN 210/gNB 212-1, AMF 226, anomaly logic 244 of NWDAF 240, LMF 250, and GMLC 252.

If there is an indication that one or more flow records for a given UE, such as UE 202, indicate an anomaly for the UE (e.g., the flow record is updated to include the anomaly flag), which may potentially be an RF impairment regarding the RAN 210, location information for the UE can be added to the flow record(s) for the UE.

In at least one embodiment, location information for a UE, such as UE 202, can be obtained through a location resolution process as shown in FIG. 8. In at least one embodiment, the location resolution process may be initiated following a determination that the UE 202 subscriber has consented to the use of their data for analytical purposes.

For the location resolution process, a location/velocity query is performed by anomaly logic 244 using the SUPI of the UE 202 subscriber towards GMLC 252, as shown at 802 (e.g., via a 3GPP ‘LCS Service Request’ message including the SUPI).

As shown at 804, the GMLC 252 invokes a position request towards the AMF 226 (e.g., a 3GPP ‘Namf_Location_ProvidePositioningInfo’ request) inkling the SUPI for the UE 202 subscriber to request the current location of the UE 202. The request may include a client type for UE 202 and may include location QoS information, a UE unaware indication, and supported GAD (Geographical Area Description) shapes.

As shown at 806, if the UE 202 is in a Connection Management idle (CM IDLE) state and the UE unaware indication is not included in the request obtained at 803, then the AMF 226 can initiate a network-triggered service request towards the UE 202, as described in Section 4.2.3.3 of 3GPP TS 23.502. Note that if the UE 202 is in a coverage hole, this service request will fail.

As shown at 808, the AMF 226 selects an LMF for location computation based on available information as prescribed by Section 5.1 of 3GPP TS 23.273. In this example, consider that AMF 226 selects LMF 250 for location computation regarding UE 202.

As shown at 810, the AMF 226 invokes a location service operation towards the LMF 250 to request the current location of the UE 202 if the UE is not in Connected state and if the “UE-unaware” flag is not set (e.g., using a 3GPP ‘Nlmf_Location_DetermineLocation’ request message). The service operation request can include an LCS correlation identifier that identifies transactions associated to the request, the serving cell identities of the main cell and primary cells (for DC scenarios), positioning QoS, positioning capability, and other indications as may be prescribed by 3GPP standards.

As shown at 812, the LMF 250 determines the UE 202 position/location (and potentially velocity/direction of movement) using available 3GPP techniques and with requested QoS precision. As shown at 814, upon determining the positioning information, the LMF 250 returns the location information towards the AMF 226 with the location computation outcome (e.g., using a 3GPP ‘Nlmf_Location_DetermineLocation’ response message). As shown at 816, the AMF 226 returns the location information to the GMLC 252 (e.g., via a 3GPP ‘Namf_Location_ProvidePositioningInfo’ response message). As shown at 818, the GMLC 252 returns location information to the NWDAF 240/anomaly logic 244, which can add the location information to the flow record(s) of the UE 202 in accordance with embodiments herein.

If a UE is in a Radio Link Failure (RLF) condition, its location/velocity may not be current and instead will be time stamped when the RLF condition is cleared. It is to be understood that other UE location resolution processes may be performed in accordance with embodiments herein. In at least one embodiment, mobile-terminated location requests (MT-LR) can be utilized such that the NWDAF 240/anomaly logic 244 can ask the GMLC 252 for location information for a specific UE. Yet, there are many ways of obtaining location information for a UE in the Connected mode. In some embodiments, the Location services (LCS) architecture, which standardizes location queries, can be utilized to obtain such information. Alternatively, proprietary methods can be used in some embodiments. It is also possible to collect location for every flow-record or every N-th flow-record as discussed for embodiments herein, in which performing more frequent location collection can result in better analytics.

### Determining/Inferring RF Impairments in a Mobile Network

As discussed for embodiments herein, an anomaly detected/identified for a UE (or multiple UEs) based on enriched flow record(s) for the UE(s) can be analyzed to determine whether the anomaly/anomalies correspond to an RF impairment in a RAN, such as RAN 210. Anomaly analysis may also be used to determine whether an anomaly/anomalies correspond to a network impairment along the user plane of a mobile network, such as the user plane of mobile network 200.

RF anomalies or impairments can be inferred/identified from enriched UE flow records in accordance with embodiments herein using any combination of online and/or offline processing techniques that may be performed by anomaly logic 244 of NWDAF 240.

At least two types of anomalous events may be considered for RF improvement or optimization through application of the embodiments herein: (1) RF coverage holes that are so severe that they trigger an RLF; and (2) handovers, which sometimes fail to complete resulting in RLFs but also could benefit from RF optimization. FIGS. 9 and 10 depict various RF anomalies/impairments that can be detected/identified by NWDAF 240/anomaly logic 244 using enriched UE flow records in accordance with embodiments herein.

FIG. 9 is a diagram depicting techniques for detecting coverage holes that may be present in a RAN based on enriched UE flow records, according to an example embodiment. FIG. 9 includes a UE 902, which is moving among different positions/locations within a RAN coverage area 910 at different times.

RLFs can be declared by a given UE when maintaining an RF connection to the network/RAN is not possible. Reconnection after an RLF can be costly, as initial access procedures are triggered between a UE and a gNB in such scenarios. In such scenarios, the UE detaches (goes into a period of silence configured by the network) and then attempts to reconnect after that period has passed (typically 100s of milliseconds to a few seconds). Some major causes of RLF conditions can include: (a) coverage holes, (b) excessive interference conditions, and (c) failed handovers. Four different configurable timers and counters, when exceeded, can trigger an RLF declaration. When a UE is in RLF condition, it is not possible to query location because, in effect, the UE is effectively disconnected from the network/RAN. A location query can occur after the UE reattaches.

Locations queries executed immediately after reconnection can help pinpoint the location of an RF impairment. FIG. 9 illustrates how such RF impairment identification might be achieved in at least one embodiment.

With refence to FIG. 9, lines 903-1, 903-2, and 903-3 may represent the actual motion (unknown) of the UE 902 across a coverage hole 913. A number of RLFs are illustrated at 906-1, 906-2, and 906-3 representing locations at which UE 902 experiences RF detach events, and a number of RF reconnections are illustrated at 908-1, 908-2, and 908-3 representing locations at which UE 902 experiences RF reconnection events.

An RLF occurs after a UE is already in a coverage hole. If the velocity of the UE 902 can be estimated (based on location queries), then it is also possible to estimate when the UE 902 entered the coverage hole 913. The time for entering the coverage hole 913 for each corresponding detach event 906-1, 906-2, and 906-3 can be represented by the radius of each corresponding circle 907-1, 907-2, and 907-3 enclosing each corresponding detach event 906-1, 906-2, and 906-3.

Note the disconnection positions of UE 902 are not known (as the UE 902 has lost its RF connection used for location resolution operations). Only the reconnection/re-attach positions of UE 902 can be determined. For example, the location of each corresponding re-attach event 908-1, 908-2, and 908-3 can be represented by the radius of each of a corresponding circle 909-1, 909-2, and 909-3 enclosing each corresponding re-attach event 908-1, 908-2, and 908-3.

User plane detection of RLFs may rely on measuring the variable time τ that a long-lived flow ceases traffic in the UL and DL directions, to meet the criteria, τ>T_{RLF} [3GPP defines different criteria for a UE to be in an RLF state: out of synchronization condition that persist for longer than the T310 timer HO failure; or maximum number of UL retransmissions reached. Thus, different criteria may be used to detect RLFs in the user plane].

In accordance with embodiments herein, user plane detection of RLF(s) can be determined by anomaly logic 244 based on UE flow records based on:
Determining that UL/DL traffic ceases significantly for a variable time (τ);
Determining that packets are lost as determined by following TCP sequency numbers and/or via inference for QUIC protocol; and/or
Determining a cell ID (NCGI) change for a UE after an RLF, which may be a consequence of a failed reattach or a failed handover.

In accordance with embodiments herein, by collecting the locations of reattaches for one or more UEs, the placement of a coverage hole, such as coverage hole 913 can be inferred statistically. For example, the polygon shown in FIG. 9 can be defined by reattach locations (e.g., 909-1, 909-2, and 909-3) may be determined by NWDAF 240/anomaly logic 244 to bound the coverage hole 913 area.

Accordingly, various statistics can be collected for detecting coverage holes in accordance with embodiments herein. For example, by collecting the locations of reattaches for multiple UEs, the location of a “coverage hole” can be inferred statistically. It is noted that reattach locations may be delayed from the actual boundary of a given coverage hole. However, UE velocity is known (e.g., inferred from location queries), the delay can be corrected. Note further, as discussed above, that detach locations may not be known unless permanent location detection is in place for a UE. These locations can be added to refine a coverage hole polygon, if available. After measurements for different UE, it may be possible to identify coverage holes as contained within a polygon with vertices associated with UE reconnection locations.

After an RLF, the UE session is retained in the 5G or LTE core, as part of the session context for the duration of the session time-out period. Hence, when a UE re-establishes within the session timeout period, the IP address(es) for established sessions will be retained. However, there are two points to note.

First, operators typically consider an RLF (particularly in low band paired Frequency-division duplexing (FDD) spectrum used for Voice-over-IP (VoIP)) to be an anomalous event and often desire to remediate such events. Embodiments herein can address these issues by monitoring the user plane for IMS data sessions and such anomalous events.

Second, if a session time-out period is exceeded, for example because the subscriber is a pedestrian walking through the area with poor coverage or is driving slowly through congested vehicular traffic, then the session context in the core is destroyed because of session timer expiration and the re-attach procedure may result in a new IP address assigned for the session. A VoIP IMS call will not just “blank,” but will actually drop. Typical time-out durations for session contexts are between 30 seconds and can be as high as 5 minutes.

FIG. 10 is a diagram depicting example UE handover (HO) details, according to an example embodiment. FIG. 10 includes a UE 1002 and a RAN coverage area 1010 that is provided by a gNB 1012-1 providing a coverage area 1013-1 and a gNB 1012-2 providing a coverage area 1013-2. In some instance, a HO can be considered a type of anomaly (e.g., if HO is unintended for a UE, if HO occurs in an inefficient manner, etc.) that may be detected by NWDAF 240/anomaly logic 244, which can be used to determine/identify one or RF impairments of a RAN.

A 5G handover (HO) typically occurs as “break-before-make” process, which is simply a way of saying that the connection is broken for a short period of time (e.g., 30 msec-100 msec) as a UE disconnects from a source gNB and then reestablishes a connection with a target gNB. In FIG. 10, a HO of UE 1002 from gNB 1012-1 to gNB 1012-2 can be represented by a break event shown at 1006 and a make event shown at 1008.

Depending on the Radio Link Control (RLC) mode, packets are buffered (or not) pending the completion of a handover procedure. In RLC acknowledged mode, used for internet access PDU sessions, no packets are lost but latency is incurred. This latency corresponds to the duration of a period where packets are buffered at the source gNB. In RLC unacknowledged mode, used for access to IP Multimedia Subsystem (IMS) PDU sessions, packets are lost, but latency is not penalized.

The acknowledged mode tends to work best when the predominant form of traffic is transport protocol-based (e.g., TCP or QUIC) because it prevents restart conditions. The unacknowledged mode is best for User Datagram Protocol (UDP)-based real-time communications where any delay is unacceptable, but packet loss is not unacceptable because analog voice and/or video samples can be reconstructed via codec interpolation. Embodiments herein can handle anomaly detection for PDU sessions differently based on the type of traffic for each PDU session.

By monitoring the user plane flow of one or more UEs, NWDAF 240, via anomaly logic 244, can discover a HO and to tag the location at which the HO occurs after triggering a location query for a given UE in accordance with embodiments herein.

In 5G, carrier aggregates and dual connectivity (DC) components follow the “canopy” coverage band that implements a HO procedure. Various criteria for identifying HO events by NWDAF 140/anomaly logic 244 may include, but not be limited to:
UL traffic ceases for a variable time (τ) because it is “break-before-make” (note DL traffic may not cease at the location of the IP probe function 230, as DL traffic can be buffered at the base station (BS)/gNB);
IF RLC Acknowledged mode is in effect (e.g., for the internet data network name (DNN)), PDU sessions can experience no packet loss but may experience a delay that can be identified by anomaly logic 244; and/or
Post-processing can be detect a NCGI (cell ID) change confirming a HO (e.g., inter-gNB, intra-gNB, with/without band reselection).

Accordingly, user plane detection of a handover (HO) can be performed by NWDAF 240/anomaly logic 244, as follows:
A HO can be detected through: (a) delay detected on connected UEs that last longer than a specified period of time, (b) cessation of UL/DL throughput, and/or (c) a change in NCGI;
Once a HO location is detected (e.g., a type of anomaly), an LCS positioning procedure can be triggered to detect the “make” reconnection location;
By collecting the locations of reconnections for multiple UEs, the location of a “handover region” can be inferred statistically. The polygon defined by the make event 1008 may bound a coverage hole 1015 area shown in FIG. 10.

Note that detach locations may not be known unless permanent location detection is provided for a UE, which can be added if desired.

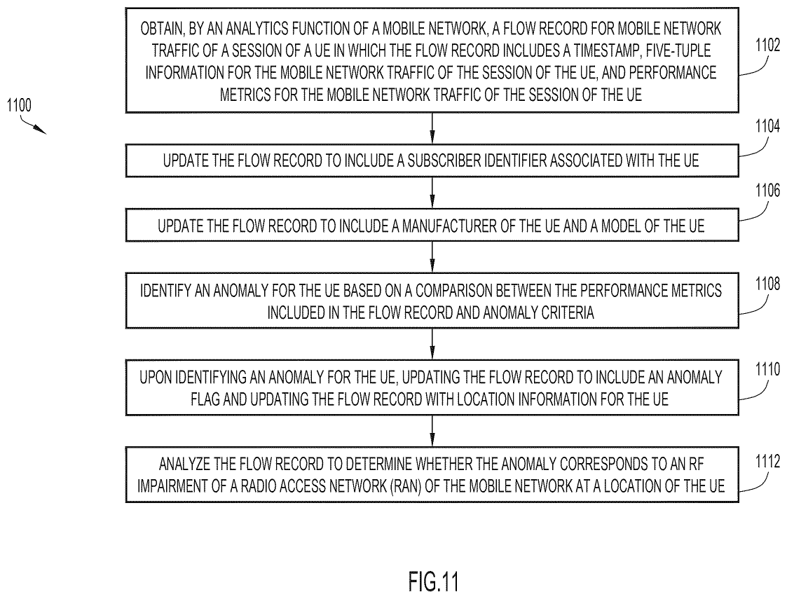

Referring to FIG. 11, FIG. 11 is a flowchart depicting a method 1100 according to an example embodiment. In at least one embodiment, method 1100 can be performed by an analytics function of a mobile network, such as NWDAF 240 of FIG. 2A.

As shown at 1102, the method can include obtaining, by an analytics function of a mobile network, a flow record for mobile network traffic of a session of a UE in which the flow record includes a timestamp, five-tuple information for the mobile network traffic of the session of the UE, and performance metrics for the mobile network traffic of the session of the UE.

As shown at 1104, the method can include updating the flow record to include a subscriber identifier associated with the UE. As shown at 1106, the method can include updating the flow record to include a manufacturer of the UE and a model of the UE.

As shown at 1108, the method can include identifying an anomaly for the UE based on a comparison between the performance metrics included in the flow record and anomaly criteria. As shown at 1110, the method can include, upon identifying the anomaly for the UE, updating the flow record to include an anomaly flag and updating the flow record with location information for the UE.

As shown at 1112, the method can include analyzing the flow record to determine whether the anomaly corresponds to an RF impairment of a radio access network (RAN) of the mobile network at a location of the UE.

Accordingly, embodiments herein may provide a method for identifying RF anomalies/impairments in 3GPP RAN by inspection of the user plane flow records for one or more UEs. Embodiments herein may facilitate correlating packet level performance included in flow record(s) for a UE when the UE is at a learned position with a possible RF impairment.

Thus, embodiments herein may allow an operator to discriminate between QoE events caused by poor RF coverage versus events that may be the consequence of packet level congestion (e.g., that may occur for a UE irrespective of the UE's location within a RAN). In some embodiments, UE flow records, generated by IP probe function 230 can be used to generate analysis that can be rendered on performance management dashboard. Enrichment with location is also possible in some embodiments. Further, one or more datasets, flow records, analysis data, etc. can be held at the NWDAF 240 via data lake 246 in accordance with embodiments herein.

Embodiments herein may also facilitate identifying degradations in QoE against known benchmarks (e.g., anomaly/QoE criteria). In at least one embodiment, such anomaly/QoE criteria may provide minimal QoE values (e.g., latency and throughput performance at a location per UE type and considering QoS policy). Once a QoE anomaly is established/determined by anomaly logic 244, flow record(s) can be tagged for any combination of online and/or offline analysis for determining RF and/or network impairments that may be present in a mobile network/RAN.

In at least one embodiment, techniques provided herein can be used to detect coverage holes and locations with poor handover performance and place them on a map. Operations facilitated through embodiments herein can be operated either in a home network or in a visited network. In at least one embodiment, the techniques herein may provide for subscriber opt-in/opt-out privacy considerations.

Data for identifying coverage holes that trigger RLF are provided through embodiments herein, as well as methods for improving HO performance.

The techniques described herein can be implemented through standards-based operations regarding signaling between various elements of a mobile network. As such, implementation of the embodiments herein may not involve additional standards development. However, the functions, operations, etc. as provided herein could be standardized, if desired.

Accordingly, radio coverage anomalies can be inferred from user plane flows utilizing embodiments as provided herein, which can be considered fundamental innovative aspects of embodiments herein.

The anomaly detection features provided through embodiments herein can be combined with time-stamped data from other sources such as probes or OAM data containing channel quality indicators (CQIs), Signal to Interference Noise Ratio (SINR), etc. to further optimize anomaly detection. In some embodiments, AI/ML methods trained on combined data set(s) can be used to improve accurate anomaly detection (including areas of weak coverage) and may implement control loops that steer the UEs to alternate RATs (Radio Access Technologies). In some embodiments, a container deployed in a cell-site router (CSR) can tap into user plane measurements and generate QoE flow records containing QoE metrics. Positioning data and RF correlations can thus be provided.

In addition to the algorithmic/logic details described herein, in at least one embodiment, another algorithm for detecting RF anomalies may:
1. Preserve computational resources on the SBA bus architecture,
2. Provide precision to RF impairment localization, and
3. Support many use cases.

As noted herein, performing a location query for every flow record received is computationally expensive. However, in at least one embodiment, a location query could be performed for every N-th flow record received for a particular user and location queries could be staggered based on a hash of an identifier (a SUPI, for example). One potential reason for staggering the locations queries (which are on a per UE basis) is because it may not be desirable for them to occur all at once. For larger ‘N’, there may be a reduced impact on processing, yet there may be a large enough value of N for which such N-th triggering of location resolution may be advantageous.

In some embodiments, location data can be combined with an RF coverage map obtained asynchronously or synchronously to show the signal strength at various locations. For example, target locations identified as polygons in a coverage map can be identified through embodiments herein. Further, additional precision can be obtained by flagging those UEs for which a periodic location query identifies them as being close to a coverage region of interest. In one instance, an operator could then turn per flow record queries for such flagged UEs. This selective approach may be useful for scenarios in which an operator is interested in the location of the specific UEs in a disaster zone. The benefit is improved statistics allowing greater precision in the identification of RF impairments.

Additionally, consider that RF anomalies impact subscribers' QoE perception. An RLF from a failed handover can result in a dropped call, a TCP time-out, and inability to use the network for a noticeable period of time. A loss of communication in a coverage hole will result in no service (no “bars”) within the coverage hole. Thus, the undisputed source of disappointment with QoE is bad RF coverage. Advantageously, embodiments herein can be used to identify such problem locations uniquely through the use of user plane data which, as discussed herein, broadly expands the use case set. There is also value associated with providing visibility to RF issues in a host network to a tenant domain.

Accordingly, various algorithms/logic for detecting RF anomalies/impairments are provided herein. Additionally, embodiments herein provide a platform for fine-tuning existing algorithms, as well as developing new ones.

In one instance, embodiments herein can enable MVNOs to measure “integral” QoE including radio measurements for service level agreements (SLA). MVNOs have a vested interest in measuring user QoE. In some embodiments, the techniques provided herein can include exposing an Application Programming Interface (API) whereby MVNOs can monitor per-user QoE on a host network.

In one instance, embodiments herein can be used to enhance a platform with a service console that can expose RF events. Similarly, the platform can offer visibility into RF and other QoE parameters to host MNO and/or end customers. In some instances, techniques provided herein can be used to flag areas for potential investments in RF coverage, can flag potential device problems, and/or can be used to optimize or fine-tune handovers between cell sites.

Today, operators perform radio network planning to maximize coverage, define power levels, adjust tilts, etc. with the objective of minimizing inter-cell interference while also maximizing coverage. This parameter adjustment is the basis of radio optimization and this is broadly accepted. However, regions with poor coverage can result from such processes. The techniques provided herein can use enriched user plane parameters to identify these regions. The techniques can be used by operators with a RAN or operators that do not have a RAN. With knowledge of this data, an operator can further optimize their network performance.

In one instance, embodiments herein can be used to enhance a platform with visibility into RAN performance. Such a platform can be provided as an as-a-service (aaS) solution operated by a vendor and delivered to MNOs that can rebrand the solution to address verticals. Thus, the techniques described herein can expose QoE to both an operator using the platform and an end customer. Accordingly, the techniques identified in this disclosure can also enhance the value of the many other platforms, tools, services, etc.

Further, per-user QoE is also important in the context of fixed-wireless access (FWA). Operators and Wireless Internet Service Providers (WISPs) are seeking to deliver services that compete with fixed wireline. FWA can be considered a special case of a mobile network where the endpoints do not move and where RF conditions, while variable, are somewhat more static. For example, FWA Customer-premise equipment (CPE) installed outdoors has a fixed geographic location which can be stored in a location database.

It is worth noting that an important control loop in a RAN is link adaptation, which operates continuously and almost instantaneously to allow a Media Access Control (MAC) scheduler in a base station (e.g., gNB) to respond to multiple conditions including the strength of the RF coverage. Embodiments herein can achieve detection of such conditions through a holistic approach that is based on monitoring a user plane enriched with identity, device type, location, etc., in essence, collecting the characterization of anomalous RF conditions through user plane data, which is where the impact is felt by subscribers, and then performing data analysis to derive inferred performance for a RAN.

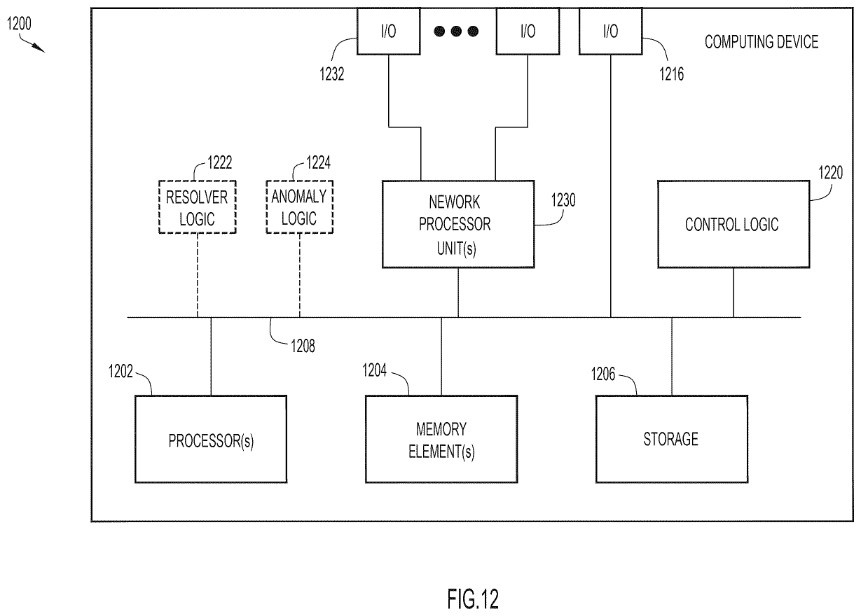

Referring to FIG. 12, FIG. 12 illustrates a hardware block diagram of a computing device 1200 that may perform functions associated with operations discussed herein in connection with the techniques described for embodiments herein. In various embodiments, a computing device or apparatus, such as computing device 1200 or any combination of computing devices 1200, may be configured as any entity/entities in order to perform operations of the various techniques discussed for embodiments herein, such as any elements, functions, functions, devices, etc. discussed for embodiments herein (e.g., NWDAF 240, IP probe function 230, any network element of mobile network 200, UE 202, etc.).

In at least one embodiment, the computing device 1200 may be any apparatus that may include one or more processor(s) 1202, one or more memory element(s) 1204, storage 1206, a bus 1208, one or more network processor unit(s) 1230 interconnected with one or more network input/output (I/O) interface(s) 1232, one or more I/O interface(s) 1216, and control logic 1220. In at least one embodiment, such as if computing device 1200 is implemented as a network analytics function, such as NWDAF 240, computing device 1200 may be configured with resolver logic 1222 and anomaly logic 1224, each of which may perform operations as discussed for embodiments herein. In various embodiments, instructions associated with logic for computing device 1200 can overlap in any manner and are not limited to the specific allocation of instructions and/or operations described herein.

In at least one embodiment, processor(s) 1202 is/are at least one hardware processor configured to execute various tasks, operations and/or functions for computing device 1200 as described herein according to software and/or instructions configured for computing device 1200. Processor(s) 1202 (e.g., a hardware processor) can execute any type of instructions associated with data to achieve the operations detailed herein. In one example, processor(s) 1202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1204 and/or storage 1206 is/are configured to store data, information, software, and/or instructions associated with computing device 1200, and/or logic configured for memory element(s) 1204 and/or storage 1206. For example, any logic described herein (e.g., control logic 1220, resolver logic 242, anomaly logic 244, resolver logic 1222, and anomaly logic 1224) can, in various embodiments, be stored for computing device 1200 using any combination of memory element(s) 1204 and/or storage 1206. Note that in some embodiments, storage 1206 can be consolidated with memory element(s) 1204 (or vice versa) or can overlap/exist in any other suitable manner.

In at least one embodiment, bus 1208 can be configured as an interface that enables one or more elements of computing device 1200 to communicate in order to exchange information and/or data. Bus 1208 can be implemented with any architecture designed for passing control, data and/or information between processors, memory elements/storage, peripheral devices, and/or any other hardware and/or software components that may be configured for computing device 1200. In at least one embodiment, bus 1208 may be implemented as a fast kernel-hosted interconnect, potentially using shared memory between processes (e.g., logic), which can enable efficient communication paths between the processes.

In various embodiments, network processor unit(s) 1230 may enable communication between computing device 1200 and other systems, entities, etc., via network I/O interface(s) 1232 (wired and/or wireless) to facilitate operations discussed for various embodiments described herein. In various embodiments, network processor unit(s) 430 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1200 and other systems, entities, etc. to facilitate operations for various embodiments described herein. In various embodiments, network I/O interface(s) 1232 can be configured as one or more Ethernet port(s), Fibre Channel ports, any other I/O port(s), and/or antenna(s)/antenna array(s) now known or hereafter developed. Thus, the network processor unit(s) 430 and/or network I/O interface(s) 1232 may include suitable interfaces for receiving, transmitting, and/or otherwise communicating data and/or information (wired and/or wirelessly) in a network environment.

I/O interface(s) 1216 allow for input and output of data and/or information with other entities that may be connected to computing device 1200. For example, I/O interface(s) 1216 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1220 can include instructions that, when executed, cause processor(s) 1202 to perform operations, which can include, but not be limited to, providing overall control operations of computing device; interacting with other entities, nodes, systems, logic (e.g., resolver logic 242, anomaly logic 244, resolver logic 1222, and anomaly logic 1224), etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1220, resolver logic 242, anomaly logic 244, resolver logic 1222, and anomaly logic 1224) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1204 and/or storage 1206 can store data, software, code, instructions (e.g., processor instructions), logic, parameters, combinations thereof, and/or the like used for operations described herein. This includes memory element(s) 1204 and/or storage 1206 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as described herein. In one form, an apparatus as described herein is provided. In one form, a system as described herein is provided. In one form, one or more non-transitory computer readable storage media encoded with software comprising computer executable instructions is/are provided herein that, when executed, is/are operable to perform operations described herein.

In some aspects, the techniques described herein relate to a method including: obtaining, by an analytics function of a mobile network, a flow record for mobile network traffic of a session of a user equipment (UE), wherein the flow record includes a timestamp, five-tuple information for the mobile network traffic of the session of the UE, and performance metrics for the mobile network traffic of the session of the UE; updating the flow record to include a subscriber identifier associated with the UE; updating the flow record to include a manufacturer of the UE and a model of the UE; identifying an anomaly for the UE based on a comparison between the performance metrics included in the flow record and anomaly criteria; upon identifying the anomaly for the UE: updating the flow record to include an anomaly flag; and updating the flow record with location information for the UE; and analyzing the flow record to determine whether the anomaly corresponds to an RF impairment of a radio access network (RAN) of the mobile network at a location of the UE.

In some aspects, the techniques described herein relate to a method, wherein the method is performed for a plurality of UEs for the location of the UE to determine whether the anomaly corresponds to an RF impairment of the RAN of the mobile network at a location of the UE.

In some aspects, the techniques described herein relate to a method, wherein the method is performed for a plurality flow records for the UE.

In some aspects, the techniques described herein relate to a method, wherein updating the flow record to include the subscriber identifier associated with the UE includes: obtaining a session management context (SMC) for the session of the UE based on a source Internet Protocol (IP) address included in the five-tuple information, wherein the source IP address corresponds to an IP address of the UE; extracting the subscriber identifier from the SMC; and updating the flow record to include the subscriber identifier.

In some aspects, the techniques described herein relate to a method, wherein the SMC for the session of the UE is obtained from one of: a cache maintained by the analytics function; or a Session Management Function (SMF) serving the session of the UE.

In some aspects, the techniques described herein relate to a method, wherein if the SMC for the session of the UE is obtained from the SMF serving the session for the UE, the method further includes: querying, by the analytics function, a Network Repository Function (NRF) of the mobile network using the source IP address included in the five-tuple information to determine the SMF serving the session for the UE; obtaining an IP address for the SMF from the NRF; querying the SMF using the source IP address included in the five-tuple information to obtain the SMC for the session of the UE; and storing the SMC in the cache.

In some aspects, the techniques described herein relate to a method, wherein updating the flow record to include the manufacturer of the UE and the model of the UE includes: obtaining a UE context (UEC) for the session of the UE based the subscriber identifier; extracting the manufacturer of the UE and the model of the UE from the UEC; and updating the flow record to include the subscriber identifier.

In some aspects, the techniques described herein relate to a method, wherein the UEC for the session of the UE is obtained from one of: a cache maintained by the analytics function; or an Access and Mobility Management Function (AMF) terminating Non-Access Stratum (NAS) signaling for the UE.

In some aspects, the techniques described herein relate to a method, wherein if the UEC for the session of the UE is obtained from the AMF terminating the NAS signaling for the UE, the method further includes: querying, by the analytics function, a Network Repository Function (NRF) of the mobile network using the subscriber identifier to determine the AMF terminating the NAS signaling for the UE; obtaining an IP address for the AMF from the NRF; querying the AMF using the subscriber identifier to obtain the UEC for the session of the UE; and storing the UEC in the cache.

In some aspects, the techniques described herein relate to a method, wherein the anomaly criteria includes at least two of: an uplink throughput threshold value; a downlink throughput threshold value; a latency threshold value; an uplink throughput variation threshold value; a downlink throughput variation threshold value; and a latency variation threshold value.

In some aspects, the techniques described herein relate to a method, the anomaly for the UE is identified based on: an uplink throughput value included in the performance metrics of the flow record being less than the uplink throughput threshold value or a downlink throughput value included in the performance metrics being less than the downlink throughput threshold value; and a latency value included in the performance metrics of the flow record being greater than the latency threshold value.

In some aspects, the techniques described herein relate to a method, wherein updating the flow record with the location information for the UE includes at least one of: updating the flow record with the location information for the UE based on identifying the anomaly for the UE; or updating a plurality of flow records for the mobile network traffic of the session of the UE for which the anomaly for the UE has been identified.

In some aspects, the techniques described herein relate to a method, further including: updating the flow record to include Radio Frequency (RF) data associated with the RAN at the location of the UE.

In some aspects, the techniques described herein relate to a method, wherein the analytics function is a Third Generation Partnership Project (3GPP) Network Data and Analytics Function (NWDAF).

In some aspects, the techniques described herein relate to one or more non-transitory computer readable storage media encoded with instructions that, when executed by a processor, cause the processor to perform operations, including: obtaining, by an analytics function of a mobile network, a flow record for mobile network traffic of a session of a user equipment (UE), wherein the flow record includes a timestamp, five-tuple information for the mobile network traffic of the session of the UE, and performance metrics for the mobile network traffic of the session of the UE; updating the flow record to include a subscriber identifier associated with the UE; updating the flow record to include a manufacturer of the UE and a model of the UE; identifying an anomaly for the UE based on a comparison between the performance metrics included in the flow record and anomaly criteria; upon identifying the anomaly for the UE: updating the flow record to include an anomaly flag; and updating the flow record with location information for the UE; and analyzing the flow record to determine whether the anomaly corresponds to an RF impairment of a radio access network (RAN) of the mobile network at a location of the UE.

In some aspects, the techniques described herein relate to a media, wherein the operations are performed for a plurality of UEs for the location of the UE to determine whether the anomaly corresponds to an RF impairment of the RAN of the mobile network at a location of the UE.

In some aspects, the techniques described herein relate to an apparatus including: at least one memory element for storing data; and at least one processor for executing instructions associated with the data, wherein executing the instructions causes the apparatus to perform operations, including: obtaining, by an analytics function of a mobile network, a flow record for mobile network traffic of a session of a user equipment (UE), wherein the flow record includes a timestamp, five-tuple information for the mobile network traffic of the session of the UE, and performance metrics for the mobile network traffic of the session of the UE; updating the flow record to include a subscriber identifier associated with the UE; updating the flow record to include a manufacturer of the UE and a model of the UE; identifying an anomaly for the UE based on a comparison between the performance metrics included in the flow record and anomaly criteria; upon identifying the anomaly for the UE: updating the flow record to include an anomaly flag; and updating the flow record with location information for the UE; and analyzing the flow record to determine whether the anomaly corresponds to an RF impairment of a radio access network (RAN) of the mobile network at a location of the UE.

In some aspects, the techniques described herein relate to an apparatus, wherein the operations are performed for a plurality of UEs for the location of the UE to determine whether the anomaly corresponds to an RF impairment of the RAN of the mobile network at a location of the UE.

In some aspects, the techniques described herein relate to an apparatus, wherein updating the flow record to include the subscriber identifier associated with the UE includes: obtaining a session management context (SMC) for the session of the UE based on a source Internet Protocol (IP) address included in the five-tuple information, wherein the source IP address corresponds to an IP address of the UE; extracting the subscriber identifier from the SMC; and updating the flow record to include the subscriber identifier.

In some aspects, the techniques described herein relate to an apparatus, wherein updating the flow record to include the manufacturer of the UE and the model of the UE includes: obtaining a UE context (UEC) for the session of the UE based the subscriber identifier; extracting the manufacturer of the UE and the model of the UE from the UEC; and updating the flow record to include the subscriber identifier.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 7®/Wi-Fi8®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by an analytics function of a mobile network, a flow record for mobile network traffic of a session of a user equipment (UE), wherein the flow record comprises a timestamp, five-tuple information for the mobile network traffic of the session of the UE, and performance metrics for the mobile network traffic of the session of the UE;
updating the flow record to include a subscriber identifier associated with the UE;
updating the flow record to include a manufacturer of the UE and a model of the UE;
identifying an anomaly for the UE based on a comparison between the performance metrics included in the flow record and anomaly criteria;
upon identifying the anomaly for the UE:
updating the flow record to include an anomaly flag; and
updating the flow record with location information for the UE; and
analyzing the flow record to determine whether the anomaly corresponds to an RF impairment of a radio access network (RAN) of the mobile network at a location of the UE.

2. The method of claim 1, wherein the method is performed for a plurality of UEs for the location of the UE to determine whether the anomaly corresponds to an RF impairment of the RAN of the mobile network at a location of the UE.

3. The method of claim 1, wherein the method is performed for a plurality flow records for the UE.

4. The method of claim 1, wherein updating the flow record to include the subscriber identifier associated with the UE includes:
obtaining a session management context (SMC) for the session of the UE based on a source Internet Protocol (IP) address included in the five-tuple information, wherein the source IP address corresponds to an IP address of the UE;
extracting the subscriber identifier from the SMC; and
updating the flow record to include the subscriber identifier.

5. The method of claim 4, wherein the SMC for the session of the UE is obtained from one of:
a cache maintained by the analytics function; or
a Session Management Function (SMF) serving the session of the UE.

6. The method of claim 5, wherein if the SMC for the session of the UE is obtained from the SMF serving the session for the UE, the method further comprises:
querying, by the analytics function, a Network Repository Function (NRF) of the mobile network using the source IP address included in the five-tuple information to determine the SMF serving the session for the UE;
obtaining an IP address for the SMF from the NRF;
querying the SMF using the source IP address included in the five-tuple information to obtain the SMC for the session of the UE; and
storing the SMC in the cache.

7. The method of claim 1, wherein updating the flow record to include the manufacturer of the UE and the model of the UE includes:
obtaining a UE context (UEC) for the session of the UE based the subscriber identifier;
extracting the manufacturer of the UE and the model of the UE from the UEC; and
updating the flow record to include the subscriber identifier.

8. The method of claim 7, wherein the UEC for the session of the UE is obtained from one of:
a cache maintained by the analytics function; or
an Access and Mobility Management Function (AMF) terminating Non-Access Stratum (NAS) signaling for the UE.

9. The method of claim 8, wherein if the UEC for the session of the UE is obtained from the AMF terminating the NAS signaling for the UE, the method further comprises:
querying, by the analytics function, a Network Repository Function (NRF) of the mobile network using the subscriber identifier to determine the AMF terminating the NAS signaling for the UE;
obtaining an IP address for the AMF from the NRF;
querying the AMF using the subscriber identifier to obtain the UEC for the session of the UE; and
storing the UEC in the cache.

10. The method of claim 1, wherein the anomaly criteria includes at least two of:
an uplink throughput threshold value;
a downlink throughput threshold value;
a latency threshold value;
an uplink throughput variation threshold value;
a downlink throughput variation threshold value; and
a latency variation threshold value.

11. The method of claim 10, the anomaly for the UE is identified based on:
an uplink throughput value included in the performance metrics of the flow record being less than the uplink throughput threshold value or a downlink throughput value included in the performance metrics being less than the downlink throughput threshold value; and
a latency value included in the performance metrics of the flow record being greater than the latency threshold value.

12. The method of claim 1, wherein updating the flow record with the location information for the UE includes at least one of:
updating the flow record with the location information for the UE based on identifying the anomaly for the UE; or
updating a plurality of flow records for the mobile network traffic of the session of the UE for which the anomaly for the UE has been identified.

13. The method of claim 1, further comprising:
updating the flow record to include Radio Frequency (RF) data associated with the RAN at the location of the UE.

14. The method of claim 1, wherein the analytics function is a Third Generation Partnership Project (3GPP) Network Data and Analytics Function (NWDAF).

15. One or more non-transitory computer readable storage media encoded with instructions that, when executed by a processor, cause the processor to perform operations, comprising:
obtaining, by an analytics function of a mobile network, a flow record for mobile network traffic of a session of a user equipment (UE), wherein the flow record comprises a timestamp, five-tuple information for the mobile network traffic of the session of the UE, and performance metrics for the mobile network traffic of the session of the UE;
updating the flow record to include a subscriber identifier associated with the UE;
updating the flow record to include a manufacturer of the UE and a model of the UE;
identifying an anomaly for the UE based on a comparison between the performance metrics included in the flow record and anomaly criteria;
upon identifying the anomaly for the UE:
updating the flow record to include an anomaly flag; and
updating the flow record with location information for the UE; and
analyzing the flow record to determine whether the anomaly corresponds to an RF impairment of a radio access network (RAN) of the mobile network at a location of the UE.

16. The media of claim 15, wherein the operations are performed for a plurality of UEs for the location of the UE to determine whether the anomaly corresponds to an RF impairment of the RAN of the mobile network at a location of the UE.

17. An apparatus comprising:
at least one memory element for storing data; and
at least one processor for executing instructions associated with the data, wherein executing the instructions causes the apparatus to perform operations, comprising:
obtaining, by an analytics function of a mobile network, a flow record for mobile network traffic of a session of a user equipment (UE), wherein the flow record comprises a timestamp, five-tuple information for the mobile network traffic of the session of the UE, and performance metrics for the mobile network traffic of the session of the UE;
updating the flow record to include a subscriber identifier associated with the UE;
updating the flow record to include a manufacturer of the UE and a model of the UE;
identifying an anomaly for the UE based on a comparison between the performance metrics included in the flow record and anomaly criteria;
upon identifying the anomaly for the UE:
updating the flow record to include an anomaly flag; and
updating the flow record with location information for the UE; and
analyzing the flow record to determine whether the anomaly corresponds to an RF impairment of a radio access network (RAN) of the mobile network at a location of the UE.

18. The apparatus of claim 17, wherein the operations are performed for a plurality of UEs for the location of the UE to determine whether the anomaly corresponds to an RF impairment of the RAN of the mobile network at a location of the UE.

19. The apparatus of claim 17, wherein updating the flow record to include the subscriber identifier associated with the UE includes:
obtaining a session management context (SMC) for the session of the UE based on a source Internet Protocol (IP) address included in the five-tuple information, wherein the source IP address corresponds to an IP address of the UE;
extracting the subscriber identifier from the SMC; and
updating the flow record to include the subscriber identifier.

20. The apparatus of claim 17, wherein updating the flow record to include the manufacturer of the UE and the model of the UE includes:
obtaining a UE context (UEC) for the session of the UE based the subscriber identifier;
extracting the manufacturer of the UE and the model of the UE from the UEC; and
updating the flow record to include the subscriber identifier.
